(19) United States
(12) Patent Application Publication
(10) Pub. No.: US 2015/0186494 A1
(43) Pub. Date: Jul. 2, 2015

(54) SYSTEMS AND METHODS FOR MESSAGE CATEGORIZATION MANAGEMENT

(71) Applicant: Google Inc., Moutain View, CA (US)

(72) Inventors: Itamar Gilad, Zurich (CH); Greg Bullock, Zurich (CH); Thompson Alexander Ivor Gawley, Palo Alto, CA (US); Andrew Ward Moedinger, Canton of Zurich (CH); Kevin Smilak, Mountain View, CA (US); Jeroen Daniël Jillissen, Menlo Park, CA (US); Balint Miklos, Zurich (CH); Jason Briggs Cornwell, Menlo Park, CA (US)

(73) Assignee: Google Inc., Moutain View, CA (US)

(21) Appl. No.: 14/145,850

(22) Filed: Dec. 31, 2013

(51) Int. Cl. G06F 17/30; H04L 12/58

(52) U.S. Cl. CPC G06F 17/30598; H04L 51/22

(57) ABSTRACT

Systems and methods for categorizing objects in accordance with one or more user categorization actions are disclosed. In some embodiments, the occurrence of one or more categorization actions is detected for a first object in a list of objects in a messaging application. Categorization actions include starring the object, dragging and dropping an object from one cluster to another, adding a new cluster label, and providing filtering rules for an object. Then a set of properties for the first object is updated in accordance with the one or more categorization actions. The updated set of properties for the first object is compared to one or more categorization rules. For instance, an exemplary categorization rule is that a starred message is to be displayed in a primary cluster. Then information for displaying the first object in the list of objects in accordance with the one or more categorization rules is prepared.

### TECHNICAL FIELD

The implementations disclosed herein relate generally to managing the categorizing of objects, such as electronic messages, in a messaging application.

### BACKGROUND

The average user account of a messaging application comprises a large number of electronic messages, such as emails, social network posts, contact information, search queries and calendar entries. Such a large number of electronic messages can be cumbersome to navigate through. Messaging application users wish to navigate through a listing of such electronic messages to quickly identify relevant messages. However, the volume of electronic messages makes it difficult to do so.

The above identified technical problems are reduced or eliminated by the systems and methods disclosed herein.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is an example block diagram illustrating a computing system, in accordance with some implementations.

FIG. 2 is an example block diagram illustrating a computing device, in accordance with some implementations.

FIG. 3 is an example block diagram illustrating a computing system, in accordance with some implementations.

FIG. 4 is an example flow chart illustrating a method for clustering objects, in accordance with some implementations.

FIG. 5 is an example flow chart illustrating a method for categorizing objects in accordance with one or more user categorization actions, in accordance with some implementations.

FIGS. 6A-6N are screen images showing example user interfaces associated with methods for categorizing objects in accordance with one or more user categorization actions, in accordance with some implementations.

FIGS. 7A and 7B are example diagrams each illustrating an example of clustering electronic messages, in accordance with some implementations.

### SUMMARY

Technical solutions (e.g., computing systems, methods, and non-transitory computer readable storage mediums) for clustering electronic messages are provided in the present application.

The following presents a summary of the invention in order to provide a basic understanding of some of the aspects of the invention. This summary is not an extensive overview of the invention. It is not intended to identify key/critical elements of the invention or to delineate the scope of the invention. Its sole purpose is to present some of the concepts of the invention in a simplified form as a prelude to the more detailed description that is presented later.

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used

In some implementations, a method is provided for categorizing objects in accordance with one or more user categorization actions. The method is performed at a computer system having one or more processors and memory storing one or more programs for execution by the one or more processors. The method further includes detecting the occurrence of one or more categorization actions. In some embodiments, the categorization action detected is the receipt of a star on an object, detecting drag & drop action of an object from one cluster to another, detecting a filtering action on an object, or the addition or modification of a label for an object. In some embodiments, the list of objects includes at least first and second objects, with the second object comprises a first message and a second message that are clustered into the second object without regard to content relatedness between the first message and the second message. Then a set of properties for the first object is updated in accordance with the one or more categorization actions. The updated set of properties for the first object is compared to one or more categorization rules. For instance, an exemplary categorization rule is a starred message is to be displayed in a primary cluster. Another exemplary categorization rule is that a starred message is also displayed in its original cluster, in other words, stars do not override or otherwise change the message's cluster classification rules. Then information for displaying the first object in the list of objects in accordance with the one or more categorization rules is prepared. In some embodiments, the method also includes displaying the first object in the list of objects in accordance with the one or more categorization rules.

In some embodiments, the first object is a single message; a first categorization action of the one or more categorization actions is starring the first object; and a first categorization rule of the one or more categorization rules is to designate a starred message with a priority cluster.

In some embodiments, the first object is associated with a first cluster (e.g. promotions cluster) of messages other than primary cluster and a second categorization rule of the one or more categorization rules is that the starred message continues to belong to the first cluster of messages.

In some embodiments, the first object is a single message, or a group of messages and prior to detecting an occurrence of the first categorization action, the first object is designated with a first cluster. An example first categorization action of the one or more categorization actions is a user dragging the first object from the first cluster and dropping the first object into a second cluster. Furthermore, an example first categorization rule of the one or more categorization rules is to designate the first object with the second cluster. In some embodiments, other subsequent messages from the originator of the first object are also designated with the second cluster. For instance, the user dragging the first object from the first cluster and dropping the first object into the second cluster also changes a first categorization rule for other messages from the originator of the first object. In other embodiments, other subsequent messages from the originator of the first object are not designated with the second cluster. For instance, dragging the first object from a first cluster and dropping the first object into a second cluster does not change a first categorization rule for other messages from the originator of the first object.

In some embodiments, a second categorization rule of the one or more categorization rules is to continue to designate the first object with the first cluster. In other embodiments, a second categorization rule of the one or more categorization rules is to no longer designate the first object with the first cluster.

In some embodiments, the first object is one or more electronic messages. Furthermore, a first categorization action of the one or more categorization actions is a user created label for the first object. For instance, the user creates a new cluster with a new name (e.g. “Work”). Then a first categorization rule of the one or more categorization rules is to designate the first object with a first cluster in accordance with the user created label (e.g., the first object should be identified with the new “Work” cluster.)

In some embodiments, prior to receiving the first categorization action, the first object is designated with a system created cluster; and a second categorization rule of the one or more categorization rules is to no longer designate the first object with the system created cluster (e.g., the first object is designated with the new “Work” cluster and not with the previous “Priority” cluster). In other embodiments, prior to receiving the first categorization action, the first object is designated with a system created cluster; and a second categorization rule of the one or more categorization rules is to continue to designate the first object with the system created cluster as well as the user created first cluster (e.g., the first object is designated with the new “Work” cluster and also continues to be designated with the “Priority” cluster as well.)

In some embodiments, the first object is one or more electronic messages. A first categorization action of the one or more categorization actions is a user created filter for the first object. The filter allows for a new designation for an object in an already existing cluster. For instance, the user created filter designates that the first object, which was previously designated with a “Promotions” cluster should now be designated with a “Travel” cluster (e.g., the “Travel” cluster previously existed but the first object was not previously not designated to the “Travel” cluster). Then a first categorization rule of the one or more categorization rules designates the first object with a cluster in accordance with the user created filter (e.g., the first object is now designated with the “Travel” cluster).

In some embodiments, the cluster is a system created cluster distinct from the first system related cluster. In other embodiments, the first cluster is a previously user created cluster (a.k.a., label) distinct from any system created clusters.

In some embodiments, prior to detecting an occurrence of the first categorization action, the first object is designated with a first system created cluster; and a second categorization rule of the one or more categorization rules is to no longer designate the first object with the first system created cluster (e.g., remove the first object from the “Promotions” cluster). In some embodiments, prior to receiving the first categorization action, the first object is designated with a first system created cluster; and a second categorization rule of the one or more categorization rules is to continue to designate the first object with the first system created cluster as well as with the first cluster (e.g., the first object is designated with the “Travel” cluster but also continues to be designated with the “Promotions” cluster as well.)

In some implementations, an electronic message is contact information, an email message, an indication of a document, a calendar entry, an email label, a social network notification, a recent search query, a suggested search query, or a web search result.

Some embodiments provide a computing system comprising one or more central processing units, CPU(s), for executing programs and also include memory sorting the programs to be executed by the CPUs. The programs include instructions to perform any of the embodiments of the aforementioned methods for categorizing objects in accordance with one or more user categorization actions. Some embodiments of the computing system also include program instructions to execute the additional options discussed above.

Yet other embodiments provide a non-transitory computer readable storage medium storing one or more programs configured for execution by a computer. The programs include instructions to perform any of the embodiments of the aforementioned methods for categorizing objects in accordance with one or more user categorization actions. Some embodiments of a non-transitory computer readable storage medium also include program instructions to execute the additional options discussed above.

Thus, these methods, systems, and GUIs provide new, less cumbersome, more efficient ways to manage and categorize objects and individual messages in accordance with one or more user categorization actions in a message clustering environment.

### DETAILED DESCRIPTION

The implementations described herein provide various technical solutions to improving access to electronic messages, and in particular to the above-identified problems, by providing techniques for displaying electronic messages to a user.

As a non-limiting example, after obtaining a string of emails (e.g., MSG 1, MSG 2, and MSG 3), a clustering system analyzes each of these emails for clustering purposes. In some cases, starting with MSG 1, the clustering system analyzes its content against a set of content-based clustering rules. In some cases, the content analysis of MSG 1 includes: (a) searching for various keywords (e.g., “deal,” “itinerary,” “profile”) within different components of MSG 1 (e.g., message body, attachment, header, and subject line) and (b) analyzing search results in accordance with content-based clustering rules (e.g., “whether the body of an email includes the term ‘Deal’ more than 3 times.”). Based on outcome of such analysis, MSG 1 is assigned to one or several categories (also referred to herein as content categories) (e.g., the “Travel” category and/or the “Promotion” category). MSG 2 and MSG 3 are similarly analyzed and also assigned categories.

Next, based on a category to which an email has been assigned (e.g., the “Travel” category, the “Promotion” category, or both), the clustering system formats these categorized emails for display to a user. For example, emails within the “Travel” category (e.g., flight tickets, rental car receipts, and hotel reservations) are displayed as a group, within a geometric shape (e.g., rectangle) encompassing the group; while emails within the “Promotion” category (e.g., an discounted Oktoberfest ticket, an invite to join the NYC restaurant week, a GOOGLE SHOPPING coupon, and an offer for a discounted ANDROID phone) are displayed as another group within another geometric shape.

Providing at least these technical effects, the proposed technical solutions described in the present application reduce or eliminate the above-identified technical problems in at least the following ways.

First, emails including different types of content and thus assigned to different content categories (e.g., clusters) are displayed concurrently, thereby providing, concurrently, a categorized view of a particular subset of emails (e.g., emails within the “Travel” cluster), as well as a comprehensive overview of a message folder (e.g., an email inbox), which usually include emails across different categories (e.g., emails within the “Travel” cluster, and those within the “Promotion” cluster). Second, emails including the same type of content (and thus assigned to the same cluster) are automatically integrated together for ease of reference.

Details of implementations are now described in relation to the Figures.

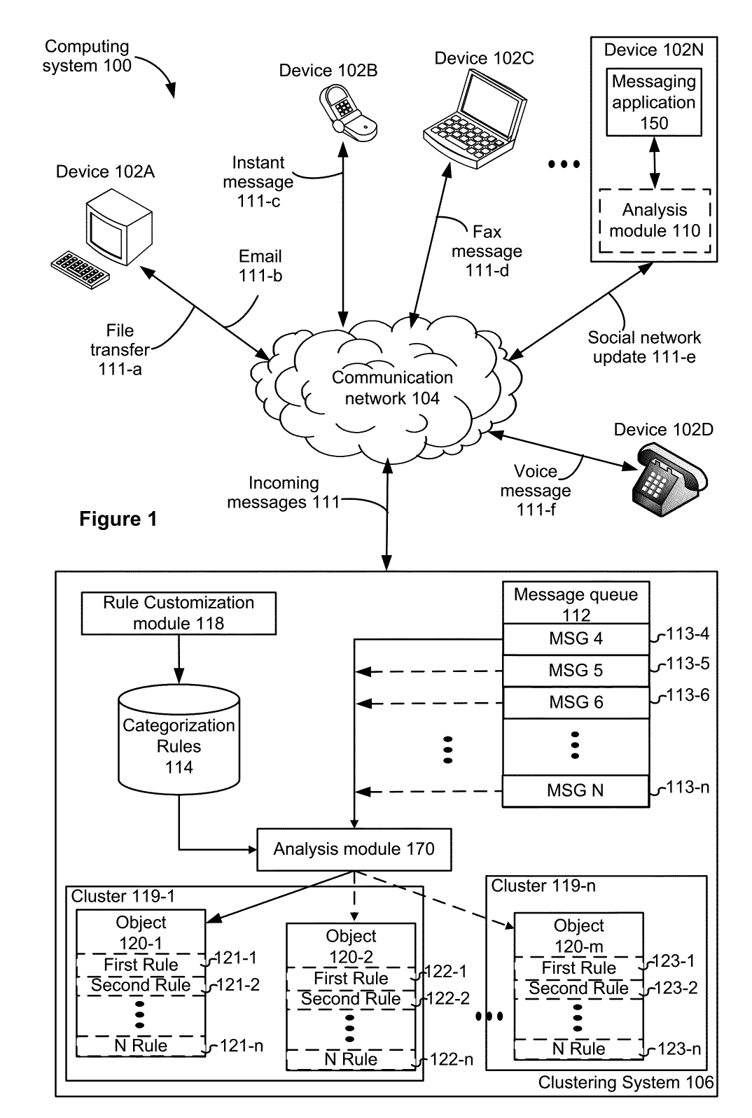

FIG. 1 is a block diagram illustrating a computing system 100, in accordance with some implementations.

In some implementations, the computing system 100 includes one or more devices 102 (e.g., device 102A, 102B, 102C, 102D . . . , and 102N), a communication network 104, and a clustering system 106. In some implementations, a device 102 is a phone (mobile or landline, smart phone or otherwise), a tablet, a computer (mobile or otherwise), a fax machine, or an audio/video recorder.

In some implementations, a device 102 obtains an electronic message from (e.g., drafted or generated by) a user of the device 102, and transmits the electronic message to the clustering system 106 for displaying with other electronic messages. For example, after determining that user Jack sends an electronic message to user Mary, the device 102 transmits the electronic message to the clustering system 106, which processes the electronic message into an object for display in a listing of electronic messages.

In some implementations, an electronic message is a file transfer 111-a (e.g., a photo, document, or video download/upload), an email 111-b, an instant message 111-c (e.g., a GOOGLE HANGOUT message), a fax message 111-d, a social network update 111-e (e.g., a GOOGLE PLUS update), or a voice message 111-f. In some implementations, an electronic message is contact information, an indication of a document, a calendar entry, an email label, a recent search query, a suggested search query, or a web search result.

In some implementations, a device 102 includes a messaging application 150 and optionally an analysis module 110. In some implementations, the messaging application 150 processes incoming and outgoing electronic messages into and from the device 102, such as an outgoing email sent by a user of the device 102 to another user, and a chat message by another user to a user of the device 102. In some embodiments the messaging application 150 is an e-mail application. In some implementations, the analysis module 110 resident on the device 102 balances processing load with the analysis module 170 resident on the clustering system 106. For example, after a user requests to send out a total of six emails, the analysis module 110 on the device 102 processes the first three emails (which include plain text emails, e.g., without HTML content or attachments, and thus might require less processing power), and the analysis module 170 on clustering system 106 processes the remaining three emails (which include HTML content or attachments, and thus might require more processing power).

In some implementations, the communication network 104 interconnects one or more devices 102 with each other, and with the clustering system 106. In some implementations, the communication network 104 optionally includes the Internet, one or more local area networks (LANs), one or more wide area networks (WANs), other types of networks, or a combination of such networks.

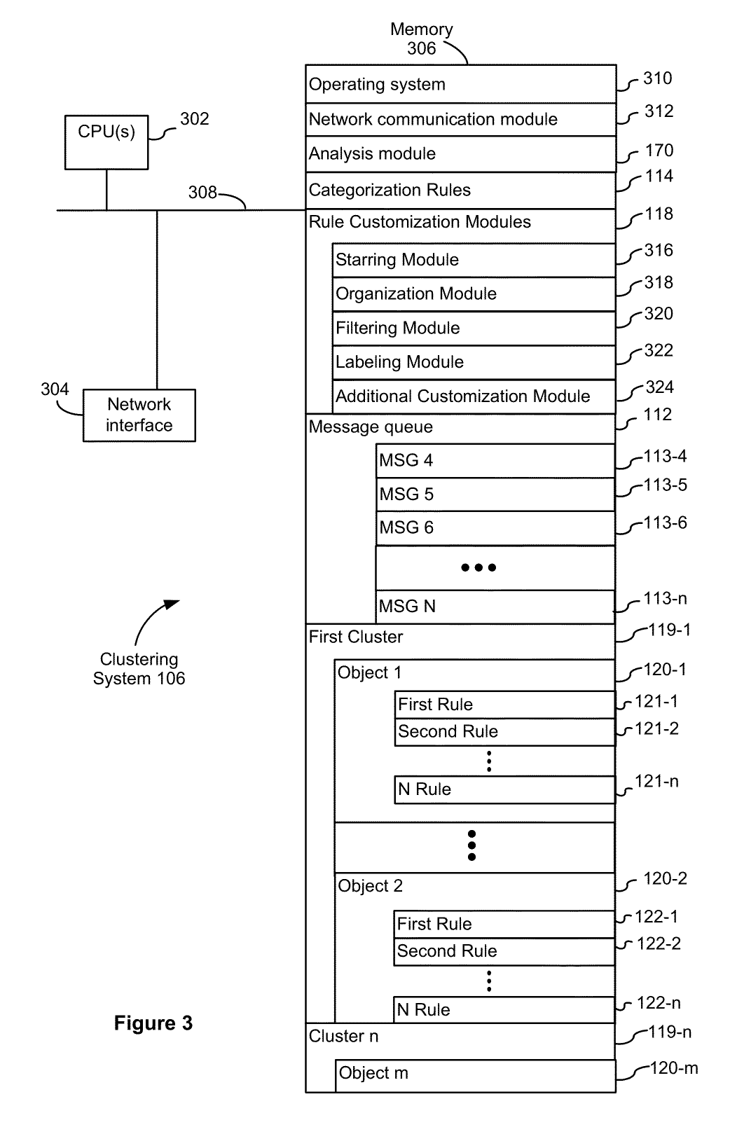

With reference to FIGS. 1 and 3, in some implementations, the clustering system 106 includes an analysis module 170, a message queue 112 and a collection of categorization rules 114 (e.g., user- or system-provided rules) and a rule customization module 118.

In some implementations, the clustering system 106 analyzes content of incoming electronic messages (e.g., incoming messages 111), and assigns these electronic messages to a cluster (e.g, 119-1 or 119-n) of one or more objects (e.g., objects 120-1 and 120-2 for cluster 119-1). In some embodiments, an object (e.g., object set 120-1) corresponds to one electronic message, with one or more categorization rules (e.g., rules 121-1, 121-2 . . . 121-n). For example, object 120-1 may consist of a single electronic message (e.g., email) from user Jack to user Mary. In some embodiments, an object (e.g., object 120-1) corresponds to more than one electronic message, with one or more categorization rules (e.g., rules 121-1, 121-2 . . . 121-n). For example, after analyzing the message body of an email, the clustering system 106 determines (e.g., with a 90% confidence level) that the email is a “Promotion” email (e.g., an email with advertising materials), and accordingly assigns the email to a “Promotion object” (e.g., object 120-2). In some implementations, assigning an email to an object includes assigning a label (a “Promotion” or “Travel” label) that represents the object. In some embodiments, an object comprises a single electronic message (e.g., a Social Network cluster comprising one social network update message). In some embodiments, an object is a message cluster. Message clusters are defined on the basis of one or more categorization rules (or clustering rules).

In some implementations, the analysis module 170 analyzes content of a new electronic message against content-based categorization rules. For example, the analysis module 170 conducts a keyword search (e.g., a search of the term “deal” or the phrase “low price”) within various content components (e.g., message body, subject line, sender/recipient, and header section) of an electronic message, and then analyzes search results using content-based clustering rules (e.g., whether the term “deal” appears more than three times within the body of an email, or whether the phrase “low price” appears within the subject line of a fax message). In some implementations, based on the analysis results, the analysis module 170 assigns an electronic message to one or more clusters; e.g., after determining that the term “deal” appears more than four times in the message body of an email and that the term “travel” appears in the subject line of the email, the analysis module 170 assigns the email to both the “Promotion” cluster and the “Travel” cluster. In some implementations, as explained in the above example, an electronic message can be assigned to more than two or more clusters. These approaches are advantageous, because sometimes an electronic message can be reasonably (e.g., objectively or otherwise) deemed to fall into two or more content categories. For example, an email promoting a discount cruise trip may be considered by some users as relevant to both “Travel” and “Promotion”; as such, the email may appear in both the “Travel” cluster and the “Promotion” cluster. In some implementations, however, an electronic message is assigned to one message cluster only. For example, in some embodiments a promotional travel message will only appear in the “Travel” cluster, but not in the “Promotion” cluster (or vice versa). These approaches are also advantageous, because user access may be simplified and user confusion minimized, when an electronic message is assigned to a single cluster and thus displayed within only a single cluster graphic (e.g., the message do not appear in any other cluster graphics).

In some cases, the clustering system 106 and/or analysis module 170 analyzes the updated set of properties for the one or more identified objects against one or more categorization rules applied to the respective objects (e.g., First Rule 121-1 and Second Rule 121-2 for object 120-1). In some cases, the same rule is applied to more than object. In some cases, an object of a particular type (e.g., a travel message cluster) is automatically assigned one or more categorization rules by the system upon its generation. In some cases, one or more of the categorization rules are user-generated, using rule customization module 118. In some cases, the one or more user-generated rules are created for only one particular object (e.g. one particular message or message cluster), while in some cases the one or more user-generated rules can be applied to more than one object (e.g. more than one message or message cluster). In some cases, there is one or more default clustering rule for all message clusters of a particular type. In some cases one categorization rule has superseding authority over all other categorization rules in the clustering system 106.

In some implementations, the analysis module 170 analyzes an electronic message against object categorization rules 114, to determine how to categorize the electronic message. For example, an incoming electronic message is first analyzed to determine if it can be categorized as a part of one or more existing objects (e.g., object 120-1 . . . 120-m). For example, if an object 120-1 comprises a single email from user Jack to user Mary, an email message comprising a reply from user Mary to user Jack would also be placed in object 120-1 by the analysis module 170. In another example, if the analysis module 170 analyzes an electronic message and determines that it is a single message corresponding to a social network post, and that none of the existing objects corresponds to social network messages (or social network messages from that social network), the analysis module 170 places the single message corresponding to a social network post into a new object.

In some implementations, the analysis module 110 is a software or hardware component resident on the device 102, such as a software package/application or a hardware chipset, for clustering electronic messages, and analysis module 170 on server 106 is not used. In some implementations, the analysis module 110 is not present and analysis module 170, which exists separate from or independent of the device 102 is used (e.g., a GOOGLE mail processing server that is connected with but not part of the device 102, e.g., in the manner depicted in FIG. 1 with analysis module 170). In still other implementations, the analysis module 110 is a software or hardware component resident on the device 102, such as a software package/application or a hardware chipset, for displaying electronic messages, and analysis module 170 on server 106 is also used. That is, both analysis module 110 on device 102 and analysis module 170 on server 106 are used. For instance, in some such embodiments some object categorization rules 114 (e.g. user-specified rules) are implemented on device 102 and implemented using analysis module 110 and some object categorization rules 114 (e.g., system-provided rules) are implemented on server 106 and implemented using analysis module 170. In some embodiments, some object categorization rules 114 are generated on server (clustering system) 106 and distributed to devices 102 for enforcement and/or implementation by analysis module 110. For instance, a set of display rules can be distributed in the form of a profile or set of rules for a user. In some embodiments, such distribution of rules to devices 102 occurs on a recurring basis (e.g., periodic or nonperiodic basis).

In some implementations, the message queue 112 stores one or more electronic messages awaiting analysis by the analysis module 170, such as MSG 4, MSG 5, MSG 6, . . . and MSG N (FIG. 1, 113-4 . . . 113-n). In some implementations, the message queue 112 includes different types of electronic messages, such as a file transfer 111-a (e.g., a photo, document, or video upload), an email 111-b, an instant message 111-c (e.g., a Google HANGOUT message), a fax message 111-d, a social network update 111-e (e.g., a GOOGLE PLUS update), a voice message 111-f, contact information, an indication of a document, a calendar entry, an email label, a recent search query, a suggested search query, or a web search result.

In some implementations, the collection of object categorization rules 114 include system- and user-specified categorization rules. In some implementations, system-provided rules are determined by the clustering system 106 (e.g., default categorization rules), and user-specified rules are customized (e.g., added, removed, or modified) by a user.

In some implementations, a rule customization module 118 enables a user to customize (e.g., add, remove, and modify) rules within the collection object categorization rules 114. These approaches enable customizing the categorization of results to a user's specific needs. For instance, users residing within the continental U.S. may consider an electronic message having the term “Alaska” to a “Travel” cluster (e.g., an electronic message with top-rated Alaska destinations) or a “Promotion” cluster (e.g., an electronic message including promotional materials for trips to Alaska); users residing in the state of Alaska, however, might consider such electronic message “Local” in nature and classify it as such. In some implementation cases, therefore, a user can personalize existing categorization rules. Continuing with the above example, in some cases, a user living Alaska can modify object categorization rules 114 such that objects including the term “Alaska” are assigned to the “Local” cluster—rather than the “Promotion” cluster or the “Travel” cluster, as users living in the continental U.S. may do. In some embodiments, this example is addressed in system-defined rules by examining the geographic source or geographic destination of the electronic message, or by otherwise determining a way to associate a geographic location with the object (e.g., by recognizing an address within the message) and applying a geographic dependent categorization rule to the message. In some embodiments, the geographic source or geographic destination is approximated based on an origination IP address or a destination IP address. To illustrate, if a geographic destination for a respective electronic message is within the continental U.S., the term “Alaska” within the message is used to assign the electronic message to a “Travel” cluster.

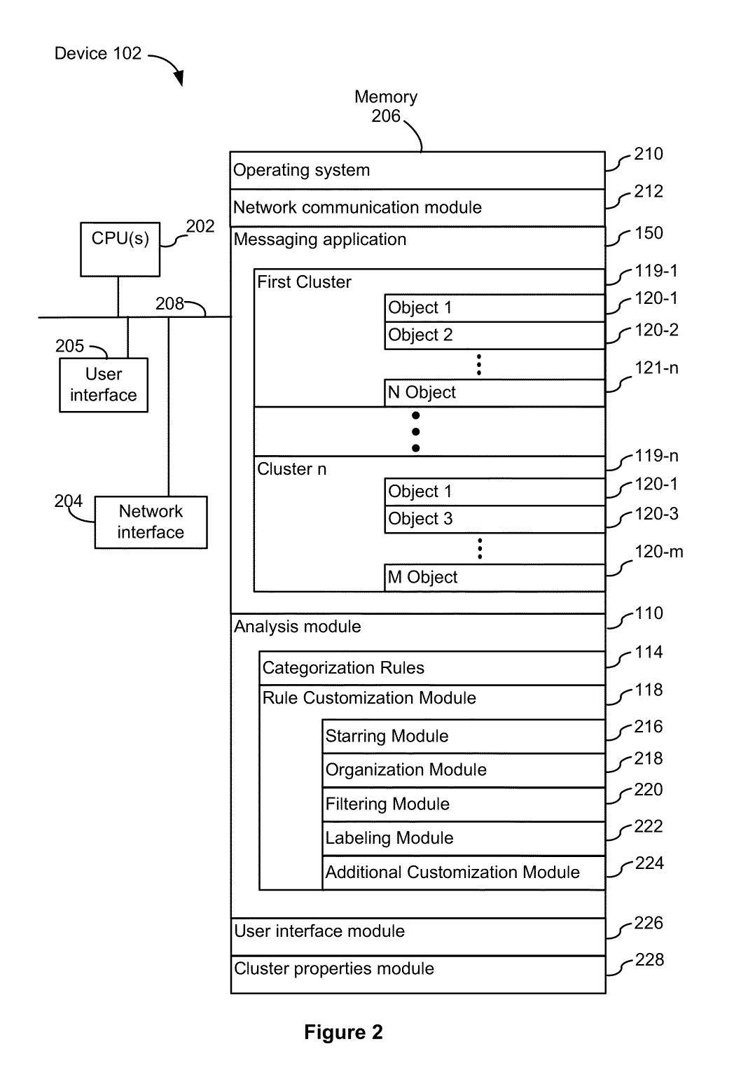

FIG. 2 is a block diagram illustrating a computing device 102, in accordance with some implementations. The device 102 in some implementations includes one or more processing units CPU(s) 202 (also referred to as processors), one or more network interfaces 204, a user interface 205, a memory 206, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the device 102 with other devices (e.g., the clustering system 106 and the devices 102B . . . 102N) via one or more network interfaces 204 (wired or wireless), or the communication network 104 (FIG. 1);
a messaging application 150 for processing and displaying incoming and outgoing electronic messages, including:
   a First Cluster (119-1) e.g., the “Primary” cluster, that includes a First Object (120-1), a Second Object (120-2), up to an Nth Object (120-n)—where an object comprises one or more electronic messages; and any number of additional clusters through
   a Object Cluster n (119-n) e.g. a “Promotion” cluster, a “Social” cluster, a “Travel” cluster etc that may include the First Object (120-1), a Third Object (120-3), up to an M^{th} Object (120-m)—where an object comprises one or more electronic messages; and
optionally an analysis module 110 for analyzing (e.g., income and outgoing) electronic messages, and assigning electronic messages to one or more object sets and clusters in accordance with therewith, in accordance with object categorization rules 114;
optionally a rule customization module 118 for allowing a user to create and/or edit categorization rules in accordance with various categorization actions;
an optional user interface module 226 for displaying user interface components or controls (e.g., textbox, button, radio button, drop-down list) to a user; and
optionally a cluster properties module 228 for updating and storing cluster properties for some or all of the message clusters.

In some embodiments, the customization module 118 includes one or more of the following: a starring module 216 to allow a user to star an object (e.g. an individual message) for inclusion in a priority cluster; an organization module 218 to allow a user to move an object from one cluster to another (e.g., by dragging dropping); a filtering module 220 for allowing a user to specify a cluster/categorization rule for an object (overriding conflicting system created categorization rules for the object), and a labeling module 222 allowing a user to customize clusters for objects (by removing system created clusters and/or crating additional clusters.) Furthermore, the customization module 118 optionally includes one or more additional customization modules 224 for providing further user customization of categorization rules.

In some implementations, the user interface 205 includes an input device (e.g., a keyboard, a mouse, a touchpad, a track pad, and a touch screen) for a user to interact with the device 102.

In some implementations, the labeling module 222 labels an electronic message using a flag in accordance with which cluster(s) the electronic message has been assigned. For example, after an email is assigned to both the “Travel” cluster and the “Promotion” cluster, the labeling module 222 assigns both the label “Travel” and the label “Promotion” to the electronic message. These approaches are advantageous, because message labels may simplify searches and selective retrievals of electronic messages, e.g., electronic messages may be searched, and retrieved, both using labels.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above. In some embodiments, the device 102 is a thin client which does not include one or more of the rule customization modules 118 (e.g., the starring module 216; organization module 218; filtering module 220; labeling module 222, etc), and as such categorization rule customization is performed in part or in whole on the server clustering system 106.

FIG. 3 is a block diagram illustrating a clustering system 106, in accordance with some implementations. The clustering system 106 typically includes one or more processing units CPU(s) 302 (also referred to as processors), one or more network interfaces 304, memory 306, and one or more communication buses 308 for interconnecting these components. The communication buses 308 optionally include circuitry (sometimes called a chipset) that interconnects and controls communications between system components. The memory 306 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 306 optionally includes one or more storage devices remotely located from CPU(s) 302. The memory 306, or alternatively the non-volatile memory device(s) within the memory 306, comprises a non-transitory computer readable storage medium. In some implementations, the memory 306 or alternatively the non-transitory computer readable storage medium stores the following programs, modules and data structures, or a subset thereof:
an operating system 310, which includes procedures for handling various basic system services and for performing hardware dependent tasks;
a network communication module (or instructions) 312 for connecting the clustering system 106 with other devices (e.g., the devices 102) via the one or more network interfaces 304 (wired or wireless), or the communication network 104 (FIG. 1);
an analysis module 170 for conducting a analysis on (e.g., incoming and outgoing) electronic messages and assigning electronic messages to one or more object sets and assigning objects to one or more clusters in accordance with the analysis;
a collection of object categorization rules 114, which specify or determine the categorization for a respective object;
a rule customization module 118 for allowing a user to create and/or edit categorization rules in accordance with various categorization actions;
a message queue 112 for storing electronic messages awaiting processing by the analysis module 170, e.g., MSG 4, MSG 5, MSG 6, . . . and MSG n (113-4 . . . 113-n); and
one or more clusters (119-1 through 119-n) each cluster having one or more objects (120-1 through 120-m) each object including one or more categorization rules (e.g. 121-1 through 121-n), exemplary rules include:
   for object 120-1;
      First Rule 121-1;
      Second Rule 121-2; and up to
      n^{th} rule 121-n; and
   for object 120-2:
      First Rule 122-1;
      Second Rule 122-2; and up to
      n^{th} rule 122-n.

In some embodiments, the customization module 118 includes one or more of the following: a starring module 316 to allow a user to star an object (e.g. an individual message) for inclusion in a priority cluster; an organization module 318 to allow a user to move an object from one cluster to another (e.g., by dragging dropping); a filtering module 320 for allowing a user to specify a cluster/categorization rule for an object (overriding conflicting system created categorization rules for the object), and a labeling module 322 allowing a user to customize clusters for objects (by removing system created clusters and/or crating additional clusters.) Furthermore, the customization module 118 optionally includes one or more additional customization modules 324 for providing further user customization of categorization rules.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 306 optionally stores a subset of the modules and data structures identified above. Furthermore, the memory 306 may store additional modules and data structures not described above.

Although FIGS. 2 and 3 show a “device 102” and a “clustering system 106,” respectively, FIGS. 2 and 3 are intended more as functional description of the various features which may be present in computer systems than as a structural schematic of the implementations described herein. In practice, and as recognized by those of ordinary skill in the art, items shown separately could be combined and some items could be separated.

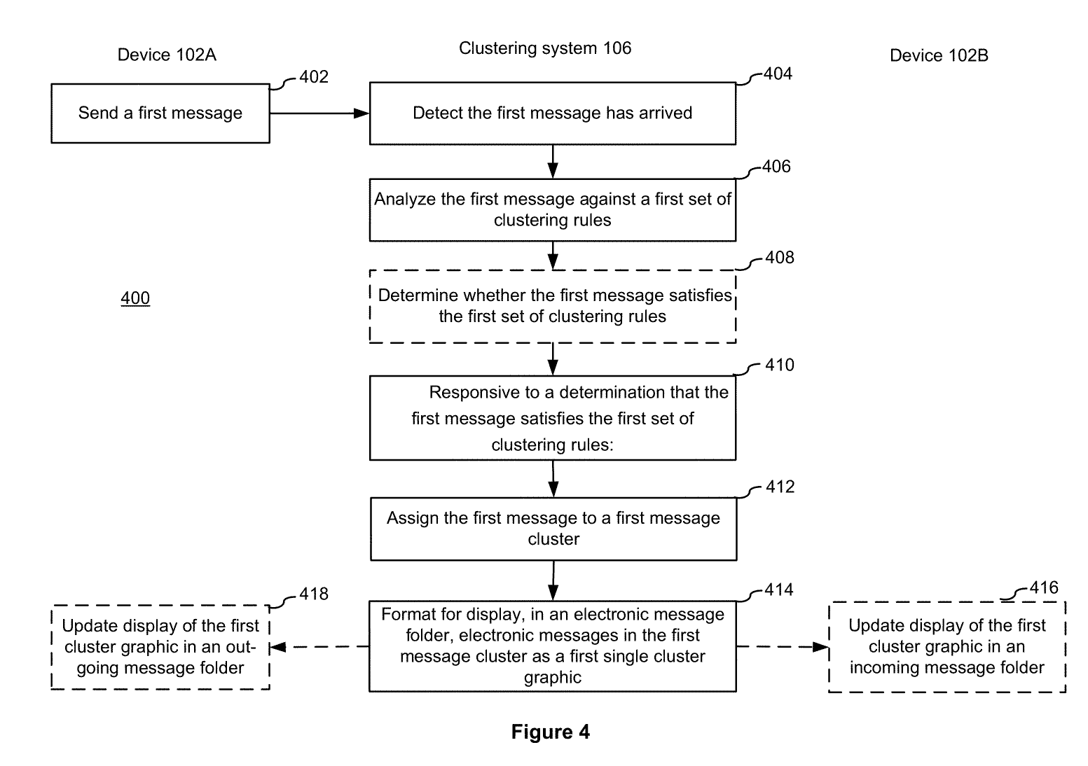

FIG. 4 is a flow chart illustrating a method for clustering electronic messages in a computing system, e.g., implemented at device 102, at the clustering system 106, in accordance with some implementations.

In some implementations, the device 102A sends (402) a first electronic message to the device 102B, via the cluster system 106.

In some implementations, after detecting (404) that the first message has arrived, the clustering system analyzes (406) the first message against a first set of clustering rules.

In some implementations, the clustering system 106 determines (408) whether the first message satisfies, e.g., to a predefined threshold degree, the first set of categorization rules/clustering rules. In some implementations, such determination is made by another computing device, such as a remote mail server or a dedicated computing server.

In some implementations, responsive (410) to a determination that the first message satisfies the first set of categorization rules/clustering rules, e.g., to a predefined extent (e.g., the first message satisfies 6 out of 10 rules specified in the first set of clustering rules), the clustering system 106 assigns (412) the first message to the first message cluster.

In some implementations, in accordance with clustering results, the clustering system 106 formats for display (e.g., resolution/size/font/position/contrast adjustments), in an electronic message folder, electronic messages in the first message cluster as a first single cluster graphic (414).

Optionally, device 102B updates a display of the first cluster graphic in an incoming message folder (416). Furthermore, optionally, device 102A updates a display of the first cluster graphic in an outgoing message folder (418). In some embodiments a cluster graphic is a tab, an icon, or some other unitary graphic representation of a cluster.

In some implementations, after obtaining a first incoming electronic message, the clustering system 106 analyzes (at 406) content of the first incoming electronic message against a first set of content-based clustering rules associated with a first message cluster, without regard to content relatedness between the first incoming message and any messages previously assigned to the first message cluster.

For example, after obtaining a portion of (or entire) content of three messages (MSG 1, MSG 2, and MSG 3), the clustering system 106 compares the content of MSG 1 (or the portion thereof) against a set of content-based rules (e.g., promotional content rules—which identifies a message as promotional in nature or as including promotional materials (e.g., targeted or untargeted advertisements), and determines whether MSG 1 meets a threshold number of criteria specified by content-based rules (e.g., whether MSG 1 meets 5 out of a total number of 10 rules in the set of rules).

In some implementations, when the clustering system determines that MSG 1 meets the threshold number of criteria specified by the first set of content-based rules (e.g., promotional content rules), the clustering system identifies (e.g., specifies, classifies, or labels) MSG 1 to be a promotional message (e.g., a realtor's news letter informing potential buyers of real properties that are currently for sale in Palo Alto, Calif.; or an invite to subscribe to a news magazine at a discounted rate). In some implementations, such a determination (specification, classification, or labeling) is accompanied by associating (also called labeling or tagging) MSG 1 with a message label representing the determination (e.g., a “Promotion” label).

In some implementations, such a message label is accessible (e.g., visually observable) to a user, so that a user can manage electronic messages using the label. For example, after receiving a user request for the “Promotions” label (e.g., a mouse selection, a combination of key strokes on a keyboard, or a voice command received through a microphone), the clustering system 106 identifies all messages (or a predefined number of messages, e.g., so as not to appear overwhelming) associated with that label, and formats these identified messages for display to a user.

In other implementations, some message labels are for system's use only (e.g., a database field/flag not accessible to a user or a user application), and thus unavailable to a user (e.g., not accessible or observable by a user).

In some implementations, the first set of clustering rules includes rules relating to message body of an electronic message. For instance, what words, phrases, and symbols are included in the body of an electronic message, e.g., whether a voice mail includes the phrase “Good Deal”; whether an email includes the symbol “$” (suggestive of a price) or “@” (indicative of an email address) more than 5 times; and whether an instant message (e.g., a chat message) includes both the word “OFFER” (e.g., case sensitive) and the word “expire” (e.g., not case sensitive). For another instance, what types or categories of content are included in the body of an electronic message, e.g., whether an electronic message includes more multimedia content (e.g., images, audios, and videos) than text (e.g., plain, and HTML or the like); and whether an electronic message includes a large number of references to additional content external to the electronic message (e.g., embedded URLs to advertising images residing on a remote server). For still another instance, whether an electronic message includes an option to unsubscribe, e.g., because sometimes legal considerations require that electronic messages with promotional content (e.g., marketing emails and cold call for insurance quotes) provide an option to unsubscribe. For still a further instance, whether an electronic message includes means for contacting a merchant, e.g., a phone number for a customer service representative for at a particular bank branch, or an email address for returns and exchanges at a local department store.

In some implementations, the first set of categorization rules/clustering rules further includes rules relating to other components of an electronic message, e.g., the subject line, name(s) of intended recipients(s), email(s) of intended recipients(s), total number of intended recipient(s) (e.g., a large number of intended recipient is indicative of a “Promotion” message), name of a sender (e.g., “GOOGLE OFFER”), email address of a sender (e.g., “Offer@google.com”), timestamps (e.g., originating or receipt, because spammers are sometimes known to send spam emails at certain time range, e.g., early hours each day); and header information (e.g., originating IP address, delivery path, intermediary SMTP addresses, a total number of hops an email has traveled before delivered, because certain geographical regions are known originations of spam emails).

Note that the above-described analysis of MSG 1 under the promotional content rules is conducted without regard (or reference) to content of MSG 2 (or a portion thereof). Stated in another way, the determination that MSG 1 is a promotional message is rendered, sometimes, without analyzing content of MSG 2—even though MSG 2 and MSG 1 may be considered related in some ways, e.g., (1) MSG 2 is a direct or indirect reply to MSG 1, (2) MSG 1 arrives before, after, or substantially contemporaneously with MSG 2, (3) both MSG 1 and MSG 2 share the same subject line, the same timestamp (receipt or send), the same author, the same intended recipient(s), the same priority level, the same signature block, the same originating IP address, or the same size; and (4) MSG 2 includes a predefine portions of MSG 1 as original or quoted text, e.g., as a result of a user's copy-and-paste of MSG 1 (or a portion thereof) into MSG 2, or of an email system's automatically (and thus without human intervention) inclusion of MSG 1 (or a portion thereof) as part of MSG 2. These approaches are advantageous, because they analyze and focus on each message individually, thereby minimizing potentially distracting elements arising from unpredictable user behaviors. For instance, after receiving a “Promotion” email (MSG 1), a user might reply (to MSG 1, a “Promotion” email) with content that may be considered unrelated to “Promotion,” such as a snippet (e.g., several sentences) concerning her recent social network status updates, which may be considered “Social” in nature. In these situations, analyzing MSG 2 individually may lead to a (in this example, better) determination that MSG 2 is a “Social” email, rather than a “Promotion” email, notwithstanding that MSG 2 is technically a reply to MSG 1 (a “Promotion” email).

Also note that although MSG 1 and MSG 2 may both eventually be determined (e.g., classified or labeled) as promotional messages, these determinations are rendered independent from each other: because both (A) the analysis of MSG 1 under the promotional content rules, and (B) the subsequent determination that MSG 1 is indeed a promotional message are carried out—without regard to both the analysis (A) and the determination (B) of MSG 2 (e.g., the content of MSG 2), and vice verse.

Further note that, because the analysis of MSG 1 against the first set of rules and that of MSG 2 against the first set of rules are independent from each other (e.g., performed in parallel or contemporaneously), in some case, the outcomes thereof would also differ. For example, when MSG 1 is an email inquiry by user 1 to user 2 about travel photos user 2 recently uploaded onto her GOOGLE PICASA page; and MSG 2 is a direct reply by user 2 that includes a significant portion of her travel itinerary, MSG 1 may be determined as relating to social network activities (e.g., labeled as “Social”); while MSG 2 may be determined as relating to travel activities (e.g., labeled as “Travel”), but not relating to social network activities (e.g., not label as “Social”), although sometimes MSG 1 and MSG 2 are considered belonging to a same conversation (e.g., a GOOGLE email conversation), due to that MSG 1 is a direct reply to MSG 2.

Notwithstanding the above, in some implementations, the content analysis of MSG 1 under the promotional content rules is conducted with—rather than without—regard (or reference) to content of MSG 2 (or a portion thereof). Stated in another way, the determination that MSG 1 is a promotional message, in some case, is rendered based at least in part on a logical relation between MSG 1 and MSG 2 or on information relating to MSG 2 (e.g., its content, header, sender/recipient, and timestamps): For example (1) both MSG 1 and MSG 2 are determined as “Promotion” emails, when MSG 1 is a “Promotion” email and MSG 2 is a direct or indirect reply or follow up to MSG 1; (2) both MSG 1 and MSG 2 share substantially the same subject line (“Travel Deals” and “Re: Travel Deals”; respectively), the same timestamp (receipt or send), the same author, the same intended recipient(s), the same priority level, the same signature block, the same originating IP address, or the same size; and (3) MSG 2 includes a predefine portions of MSG 1 as original or quoted text, as a result of a user's copy-and-paste of MSG 1 (or a portion thereof) into MSG 2, or of an email system's automatically (and thus without human intervention) inclusion of MSG 1 (or a portion thereof) as part of MSG 2. These approaches are advantageous, because to determine (or classify) the nature of an electronic message, they take into consideration a temporal, causal, or other logical relationships between two or more electronic messages, which might otherwise be lost or obscured when electronic messages are analyzed individually (e.g., in isolation).

In some implementations, after completing the analysis of MSG 1 against the first set of rules (e.g., Promotions Rules), the computer system continues with MSG 1 (rather than moving to MSG 2 or MSG 3) by analyzing MSG 1 with a second set of content-base rules (e.g., social network content rules) which identifies a message as relating to social network activities (e.g., an invite to join a GOOGLE PLUS circle, or a summary of recently-available content on YOUTUBE.COM). In some implementations, therefore, an electronic message is identified as belonging to two or more clusters (e.g., both the “Travel” cluster and the “Promotion” cluster).

In some implementations, after completing the analysis on MSG 1, process control moves onto MSG 2, and begins analysis of MSG 2 and MSG 3, in parallel or in sequence, against the first set of content-based rules.

In some implementations, responsive to (410) a determination that the first incoming electronic message satisfies the first set of clustering rules, the clustering system 106 assigns (412) the first incoming electronic message to the first message cluster.

In some implementations, the first set of clustering rules is specified without user intervention. For example, the first set of content-based clustering rules includes rules defined or provided by the clustering system 106 (e.g., pre-programmed rules loaded from a rule database). In some implementations, these system-defined clustering rules are not modifiable by a user.

In some implementations, these system-defined clustering rules are customizable by a user. In some implementations, the first set of clustering rules is user specified. As an example, the first set of clustering rules includes rules defined or provided by a user (e.g., user-customized rules), via the rule customization module 118 shown in FIG. 1. As another example, a user can customize or personalize clustering rules (e.g., adding new rules and modifying or removing existing rules), e.g., in order to improve clustering accuracy and to tailor clustering rules to his or her particular needs. For instance, for a user living in a community (or at a geographical location) where the word “deal” has become an email or chat slang, the user may modify an existing clustering rule (from “an email that includes the keyword ‘deal’ is a promotional email” to “an email that includes the keyword ‘deal’ and the keyword ‘price’ at least twice—is a promotional email) in order to avoid having emails or chats from her friends classified (or misclassified) as advertisements.

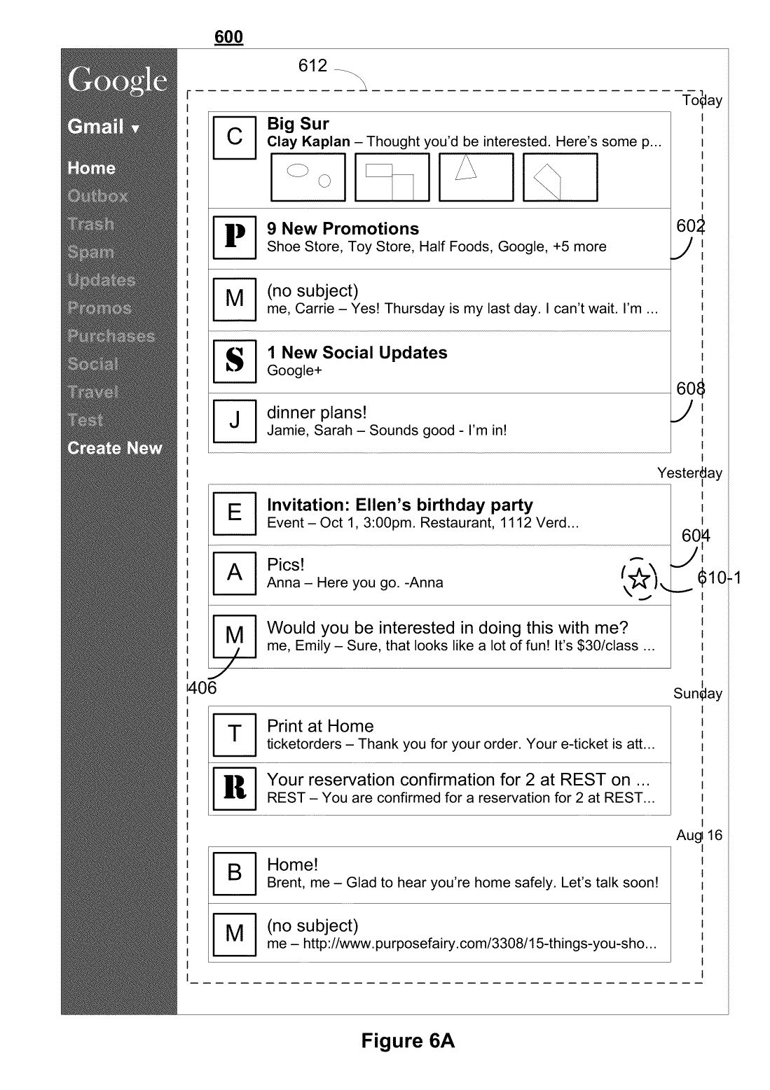

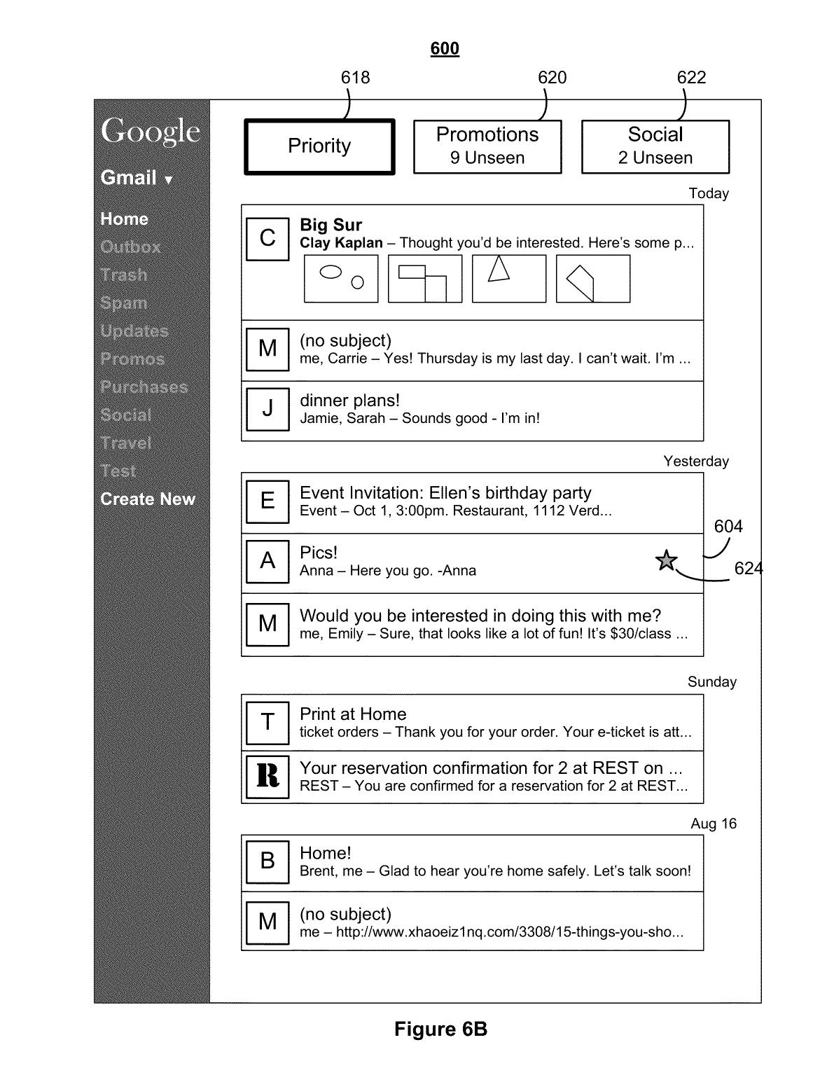

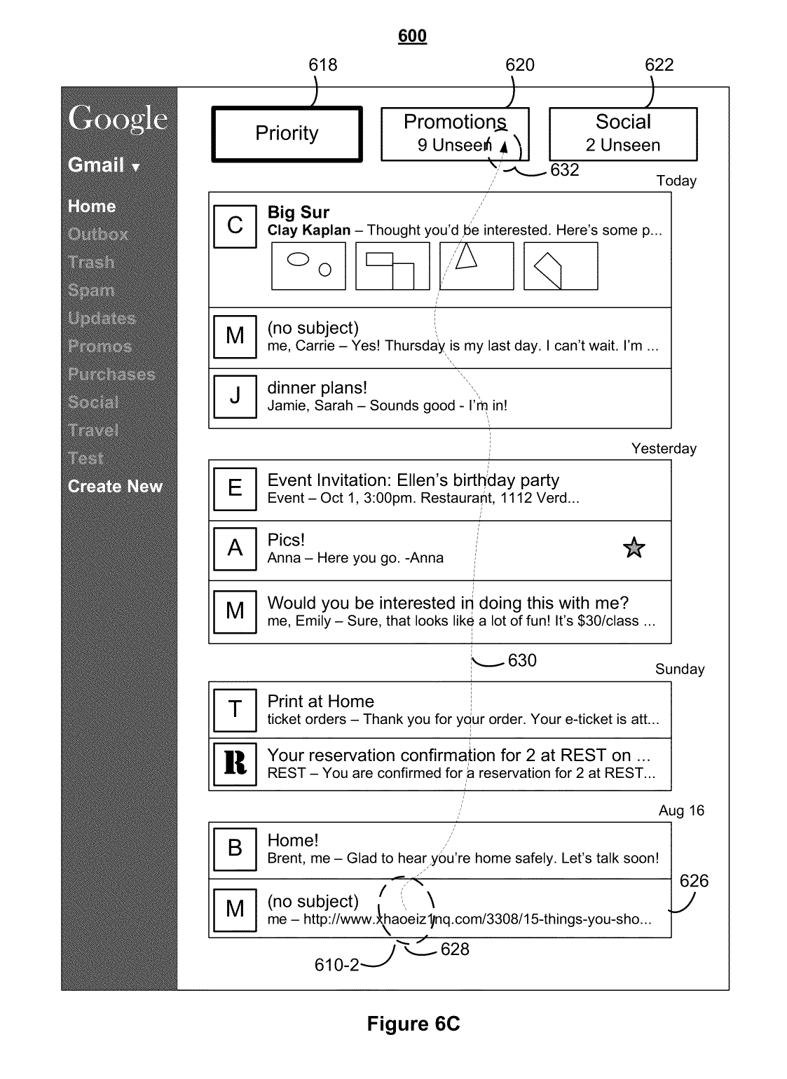

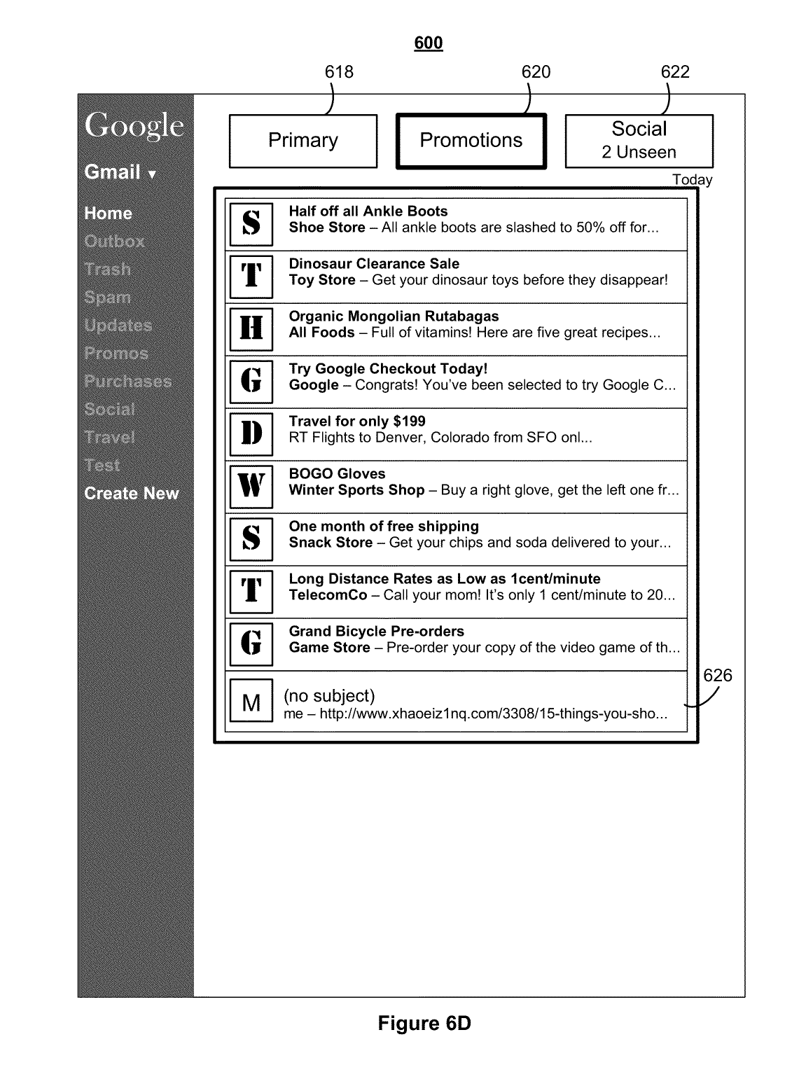

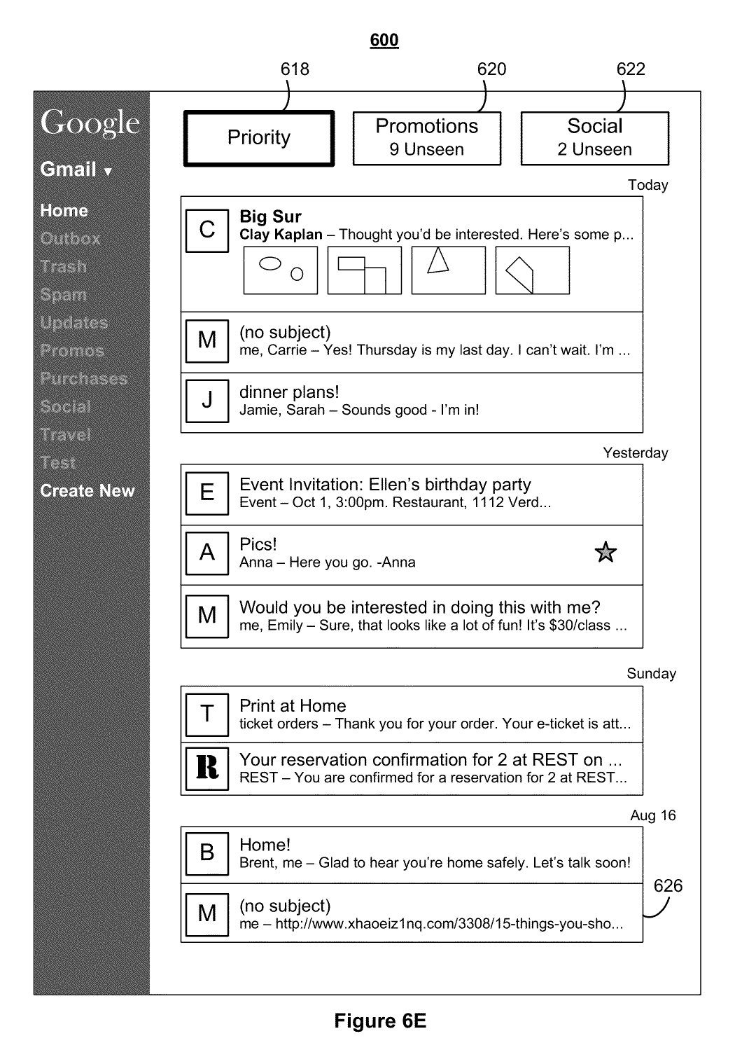

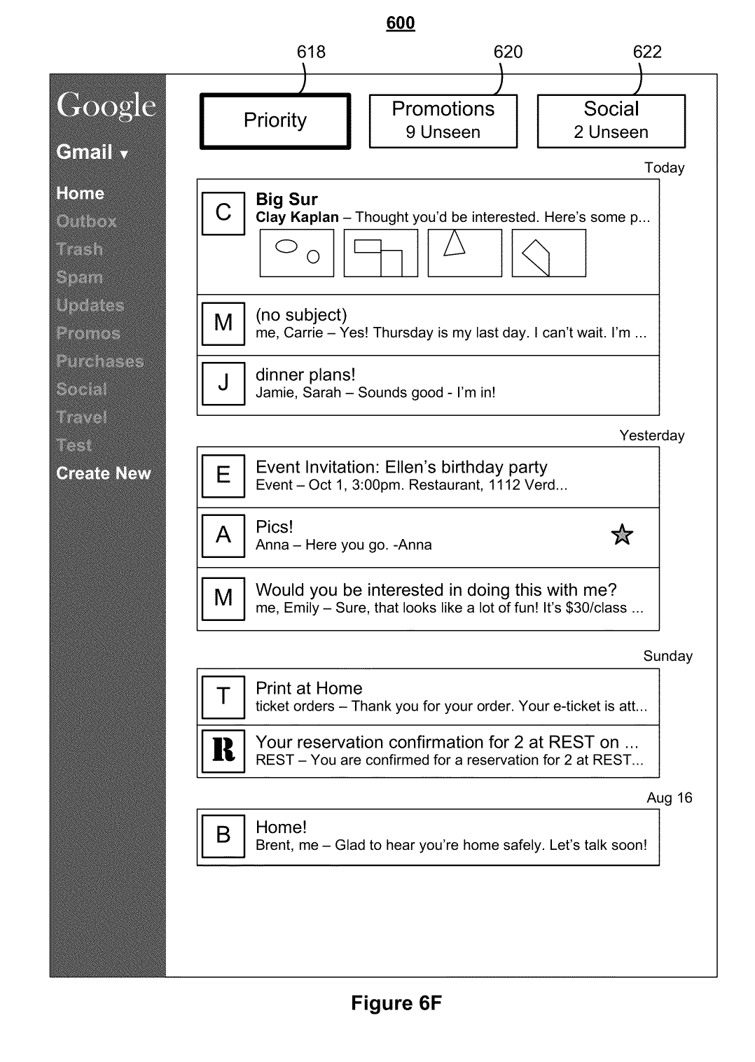

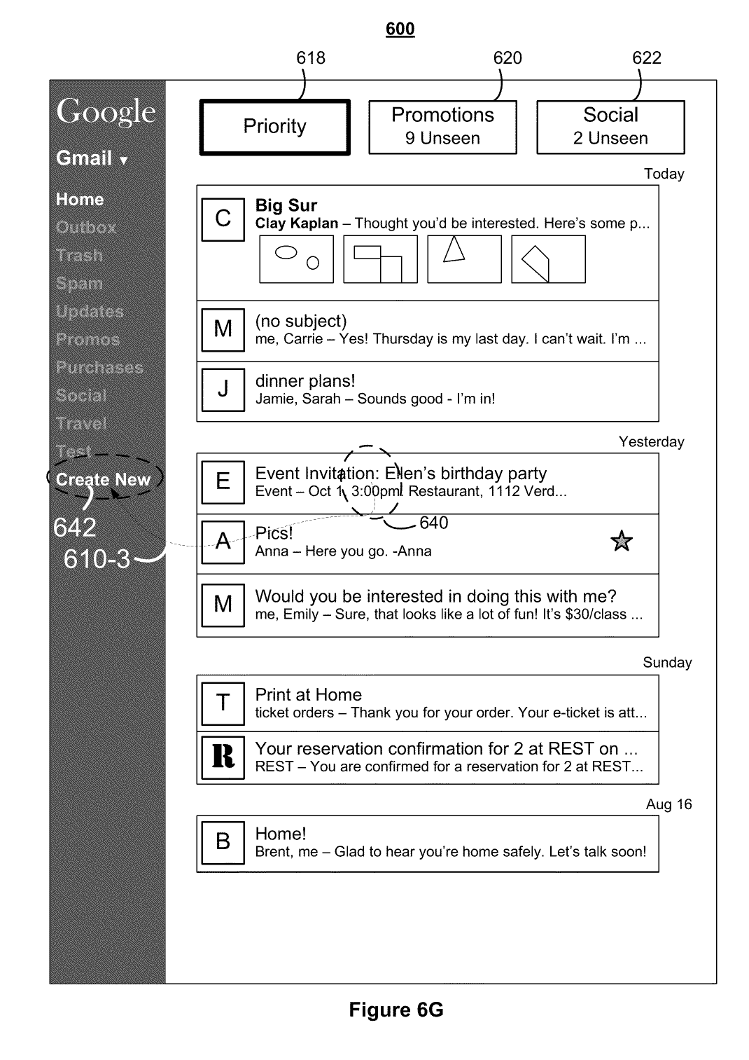

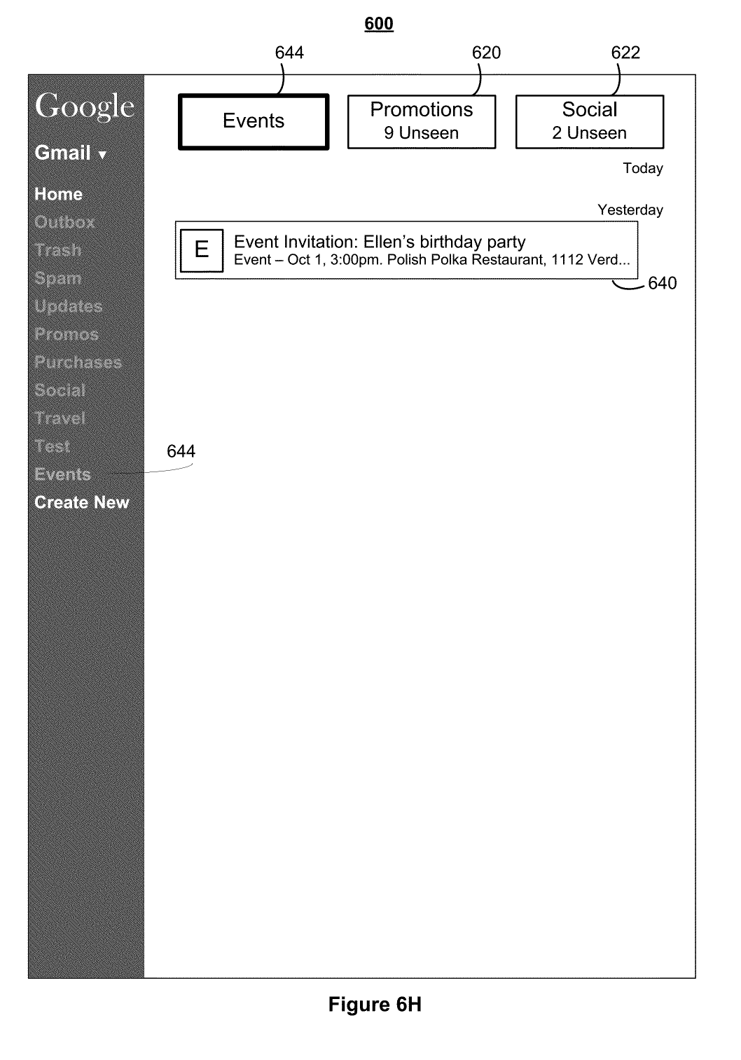

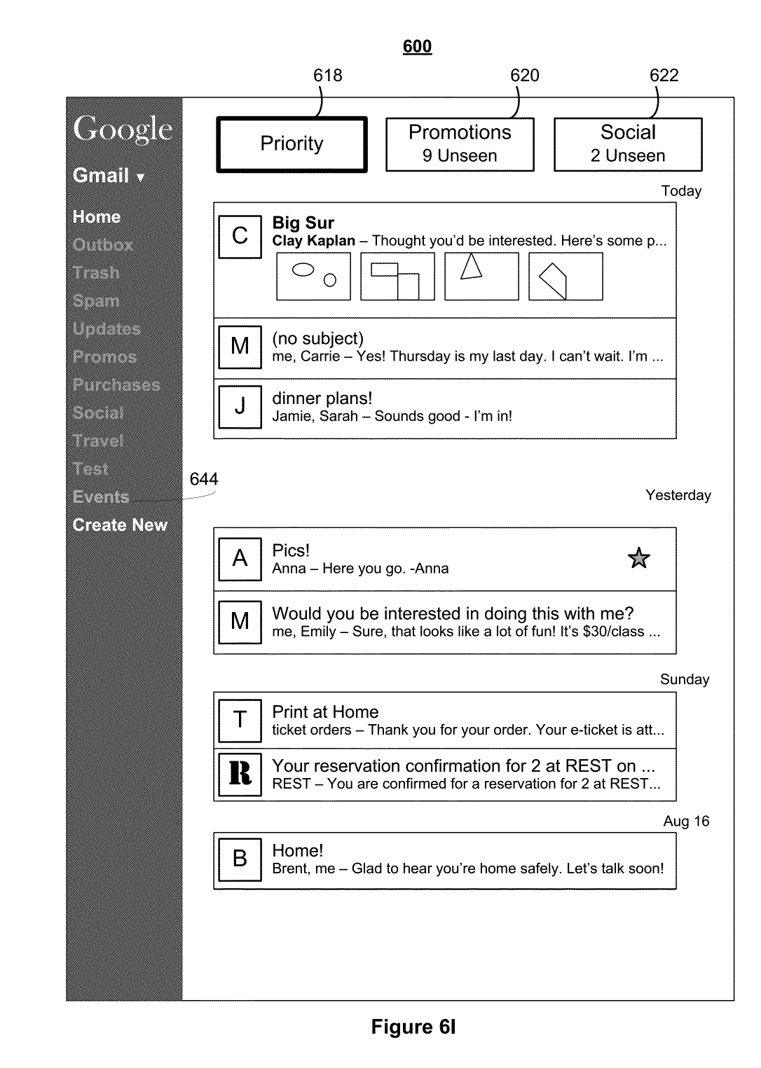

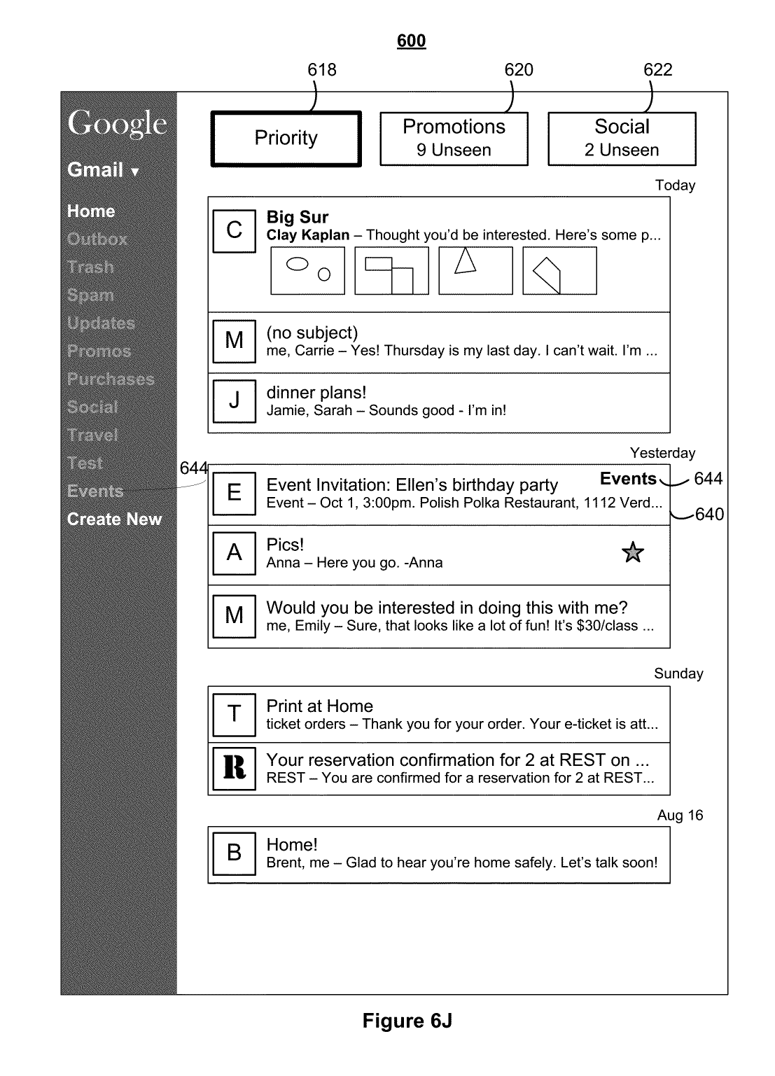

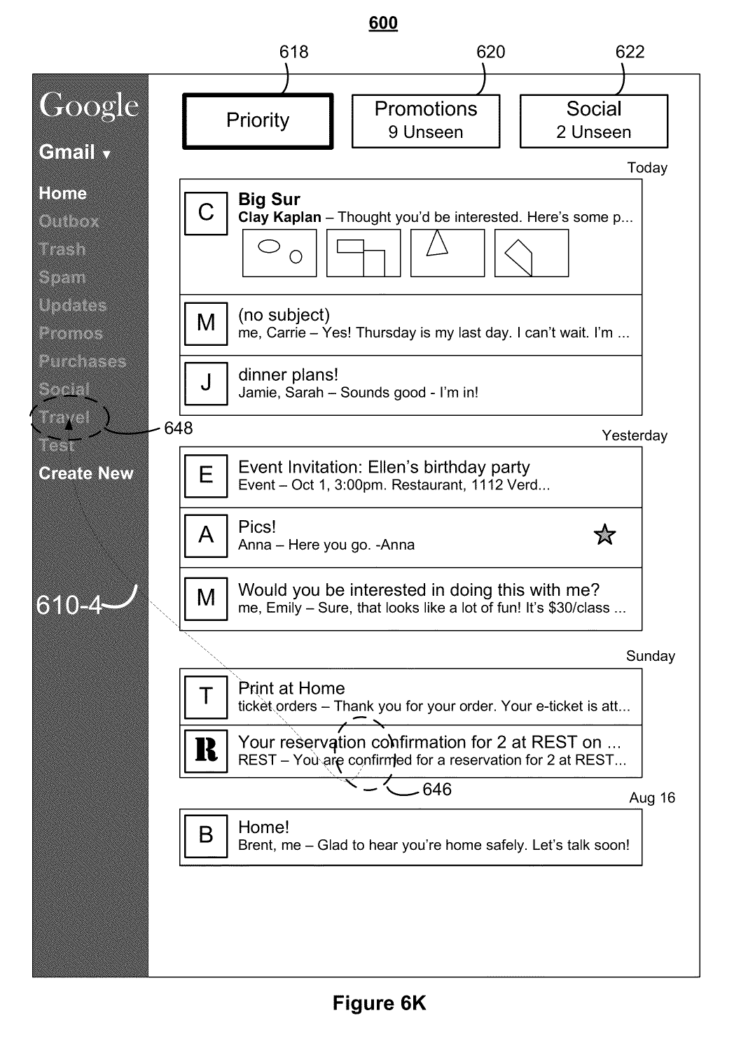

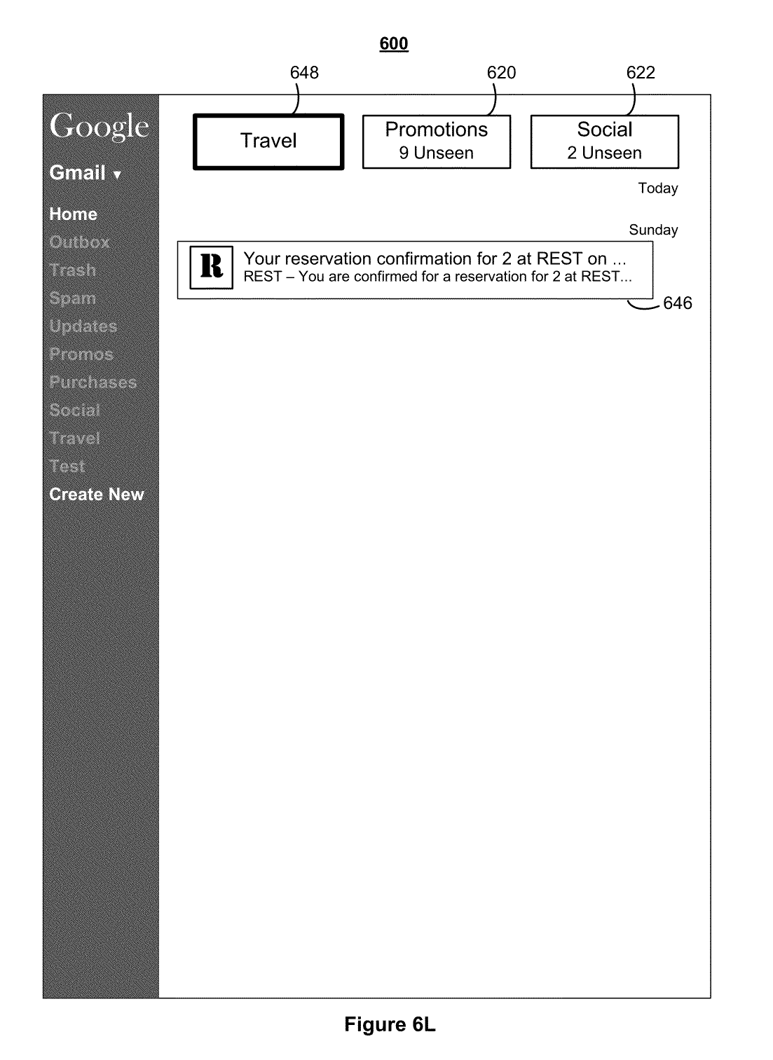

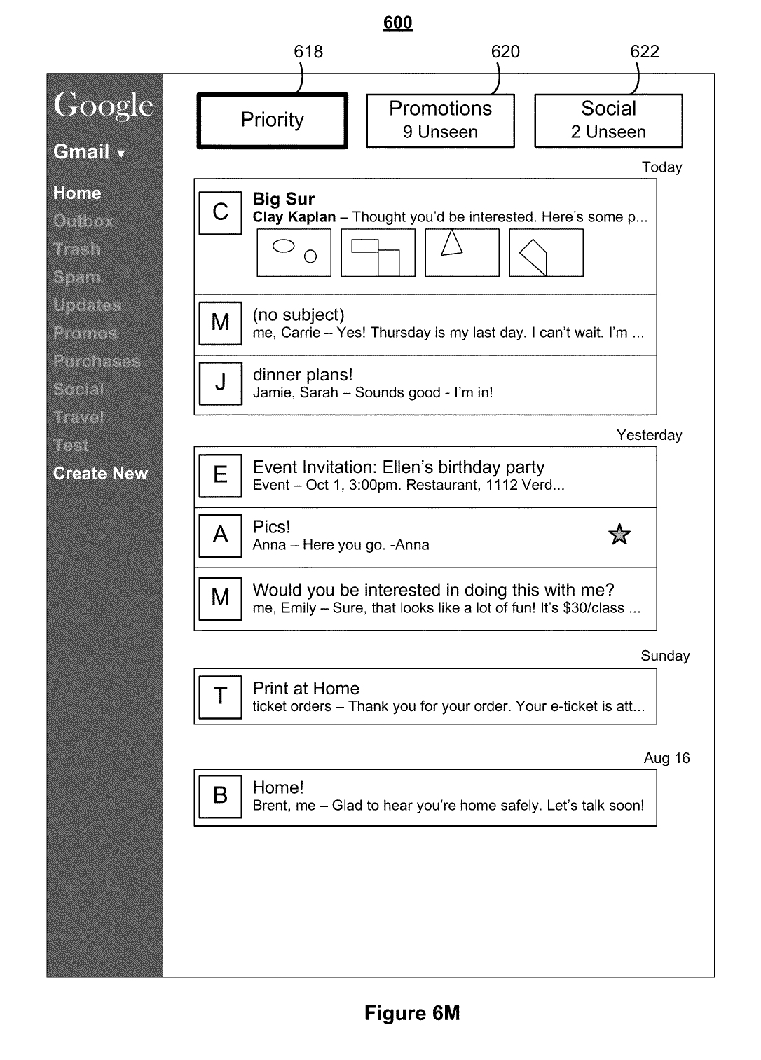

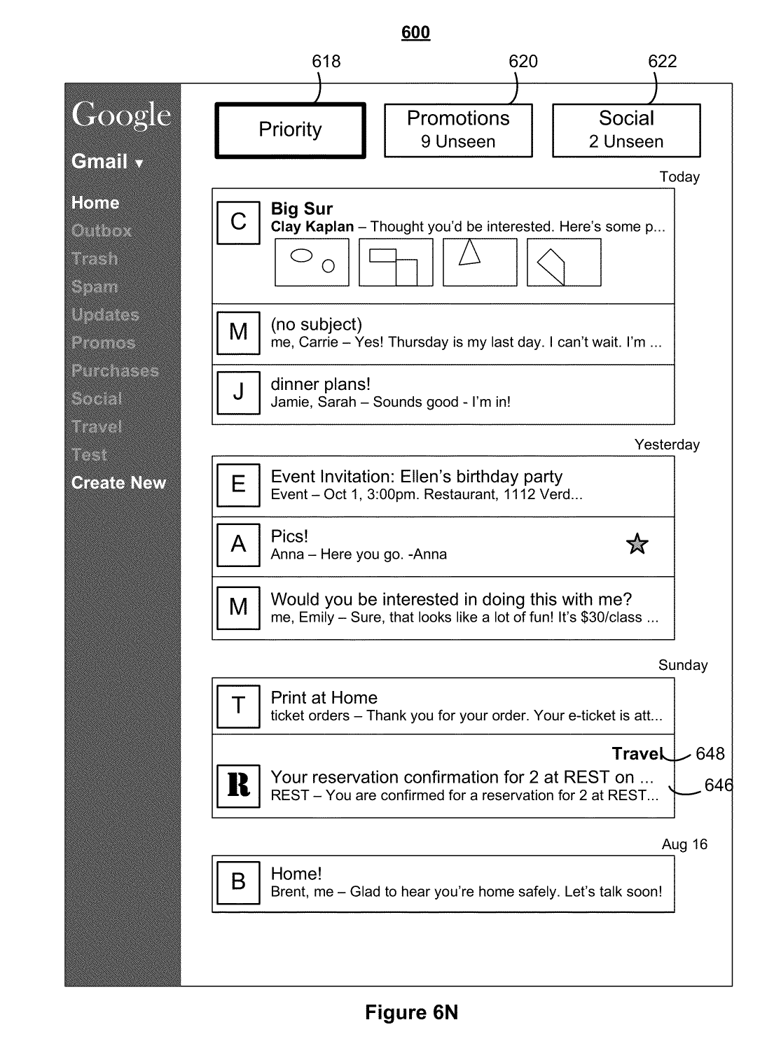

In some implementations, the clustering system 106 then formats (414) for display, in an electronic message folder, electronic messages in the first message cluster as a first single cluster graphic. As an example, after determining that a message a “Promotion” email, the clustering system causes the message to be visually (e.g., graphically) displayed, together with other “Promotion” messages (e.g., emails, tweets, chat messages, etc) as a single cluster graphic, e.g., a closed-form shape (rectangle, circular, or otherwise) that includes all or a portion of “Promotion” message), as shown in FIG. 6D.

Note that, in some implementations, the single cluster graphic differs from an electronic message folder (e.g., an email inbox, a spam folder, and a trash folder) in at least the following ways.

First, an email inbox includes emails of several different types or categories (e.g., both “Promotion” and “Travel” emails); whereas the single cluster graphic includes (e.g., only) emails of a particular type or category (e.g., the “Promotion” cluster graphic includes “Promotion” emails, but not “Travel” email). The clustering methods described herein are therefore advantageous because they simplify user access to a particular type or category of electronic message. For example, a user looking for a CVS coupon attachment would only search the single cluster graphic representing (e.g., including) “Promotion” electronic messages, rather than searching the entire email inbox, which often includes a much greater number of emails than the “Promotion” cluster does.

Second, an email inbox includes emails; whereas, in some cases, the single cluster graphic includes content other than emails, such as chat messages, tasks, and notes (e.g., all relating to “Social”). The clustering methods described herein are therefore advantageous because they provide a comprehensive access to different content having a similar nature (“Promotions” rather than “Social”).

Further note that, in some implementations, the clustering process differs from a filtering process (e.g., email filters) in at least the following ways. For example, an email filter does not cause “Promotion” emails to be displayed as a single cluster graphic, as shown, in FIG. 6D. For another example, in some cases, email filters do not specify content-based rules (e.g., a filter specifying that “all emails arrived between today and Monday next week are to be achieved without delivery to inbox first”).

In some implementations, a “single inclusion” feature is provided. For example, after determining that an electronic message can potentially be clustered into two or more system-provided clusters, the cluster system 106 places the electronic message into one system-provided clusters, but not the other system-provided cluster, e.g., to avoid potential confusion (which might arise if/when a same message is duplicated in several message clusters and thus displayed in several cluster graphics). In some implementations, the first incoming electronic message further satisfies a second set of content-based clustering rules associated with a second message cluster, and the clustering system 106 forgoes association of the first incoming electronic message with the second message cluster. In some implementations, the first and second sets of content-based clustering rules are system-defined clustering rules. As another example, after analyzing an electronic message that includes both detailed description of recommended travel destinations in Alaska and ongoing promotions on cruise trips to Alaska, the clustering system 106 determines that the electronic message can be potentially classified as both “Travel” and “Promotion.” If, however, the electronic message is deemed to include more “Travel” related characteristics than “Promotion” related ones, e.g., the electronic message was sent by a well-known travel organization (e.g., the AAA club) rather than by a establish online merchant (e.g., the GOOGLE OFFERS system), the electronic message is placed in the “Travel” cluster, but not in the “Promotion” cluster.

In some implementations, a “multi-inclusion” feature is enabled. For example, after determining that an electronic message can potentially be clustered into two or more user-provided clusters, the cluster system 106 places the electronic message into both user-provided clusters, which may better fit a user's particular need. In some implementations, the first incoming electronic message further satisfies a second set of content-based clustering rules associated with a second message cluster, and the clustering system 106 assigns the first incoming electronic message to the second message cluster, and formats for display, in the electronic message folder, the electronic messages in the second message cluster as a second single cluster graphic. In some implementations, the first and second sets of content-based clustering rules are system-defined clustering rules. In other implementations, the first set of content-based clustering rules is system-defined clustering rules, and the second set of content-based clustering rules is user-defined clustering rules. As another example, after analyzing an electronic message that includes both detail description of travel destinations in Alaska and ongoing promotions on cruise trips to Alaska, the clustering system 106 determines that the electronic message can be classified as both the “Travel” cluster (a system-defined cluster) and the “Promotion” cluster (a system-defined cluster). These approaches are advantageous as they, in some cases, more accurately reflect the content of the electronic message and user expectations. In the above example, the content of the electronic message relates to both “Travel” and “Promotion”. As such, a user might expect the electronic message to display in both the “Travel” cluster graphic and the “Promotion” cluster graphic.

In some implementations, a feature sometimes referred to as “an action on one is an action on all” is provided. In some implementations, the first message cluster comprises a first plurality of electronic messages, the first plurality of electronic messages including the first incoming electronic message. The method further comprises, responsive to a predefined user action with respect to the first single cluster graphic, causing the predefined user action to be applied to each electronic message in (or associated with) the first plurality of electronic messages. In some implementations, the predefined user actions include one of the following: delete, archive, label, mark as not read, and mark as not seen. For example, in some cases, deleting the “Promotion” cluster causes messages (e.g., emails, chat messages, and tasks, such as messages within the “Promotion” cluster to be deleted.

In some implementations, an electronic message already assigned to a message cluster can be disassociated from the cluster. In some implementations, responsive to a predefined user action in connection with an electronic message included in the first message cluster the clustering system 106 disassociates the electronic message from the first single cluster graphic. For example, as shown in FIG. 6F, the message 626 (previously shown in FIG. 6C) is removed from the priority cluster 618 and thus no longer displayed. In these ways, a user may—with or without modifying clustering rules—further customize a message cluster by, e.g., using drag and drop, removing existing messages from a cluster, or adding new messages to the cluster.

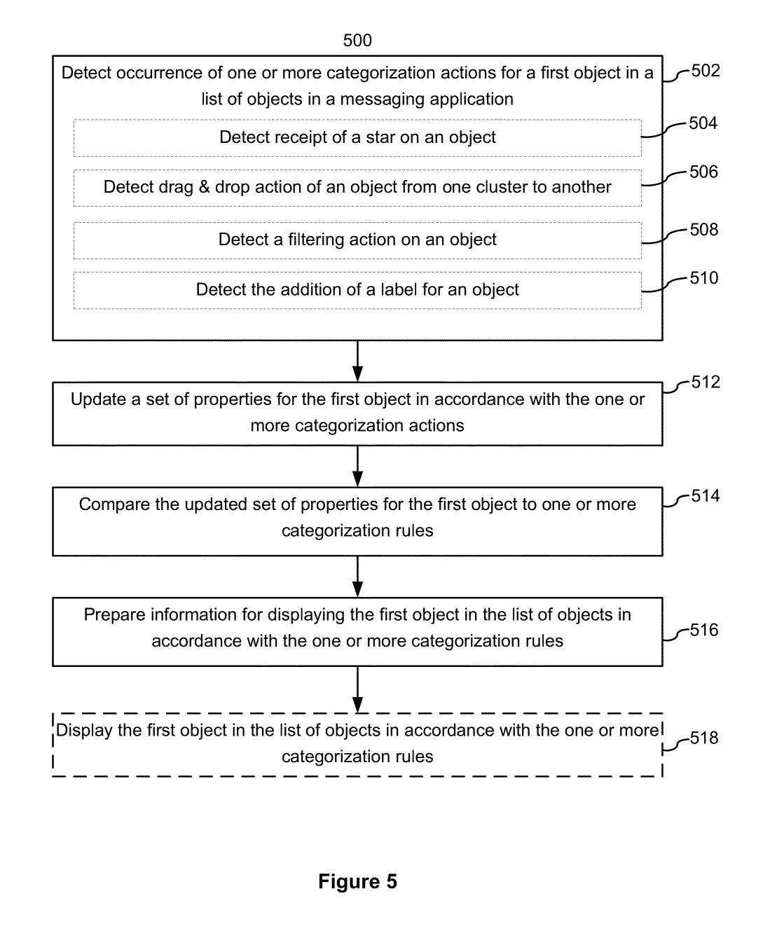

FIG. 5 illustrates a flow chart for method 500 of categorizing objects in accordance with one or more user categorization actions, according to certain some embodiments. The method 500 is typically governed by instructions that are stored in a computer readable storage medium and that are executed by one or more processors of one or more servers or clients depending on the embodiment. Each of the operations shown in FIG. 5 typically corresponds to instructions stored in a computer memory or non-transitory computer readable storage medium. The computer readable storage medium typically includes a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically many of the operations shown in FIG. 5 correspond to instructions in the memory 206 of the client device 102 shown in FIG. 2 or the memory 306 of the clustering system server 106 shown in FIG. 3.

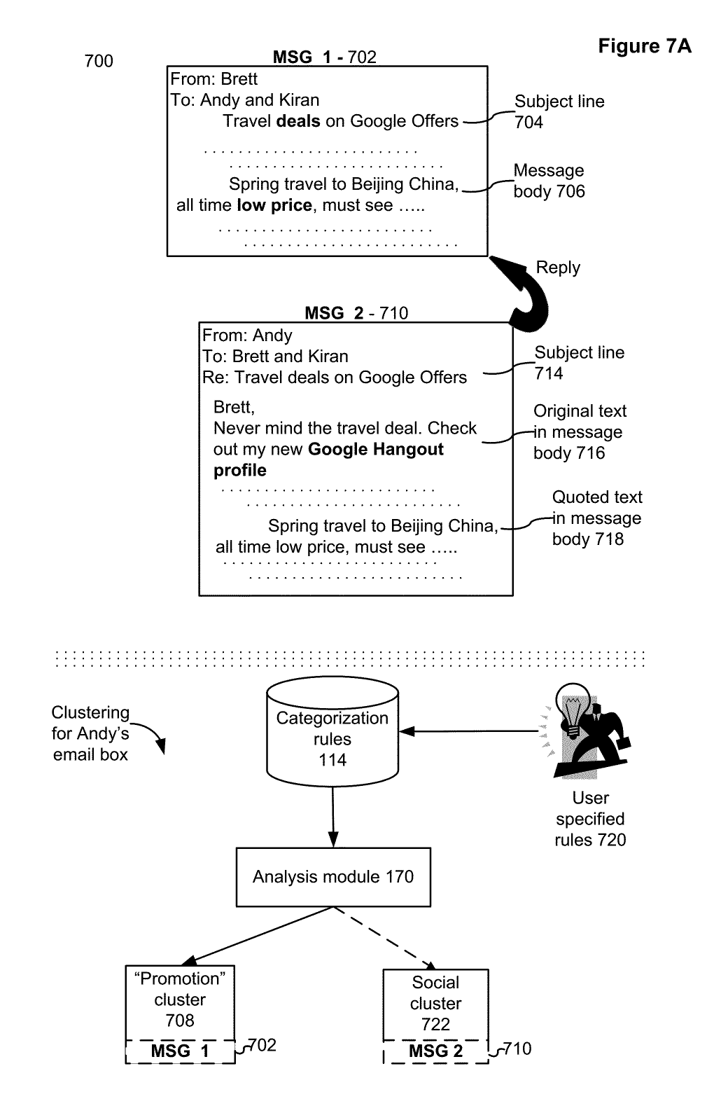

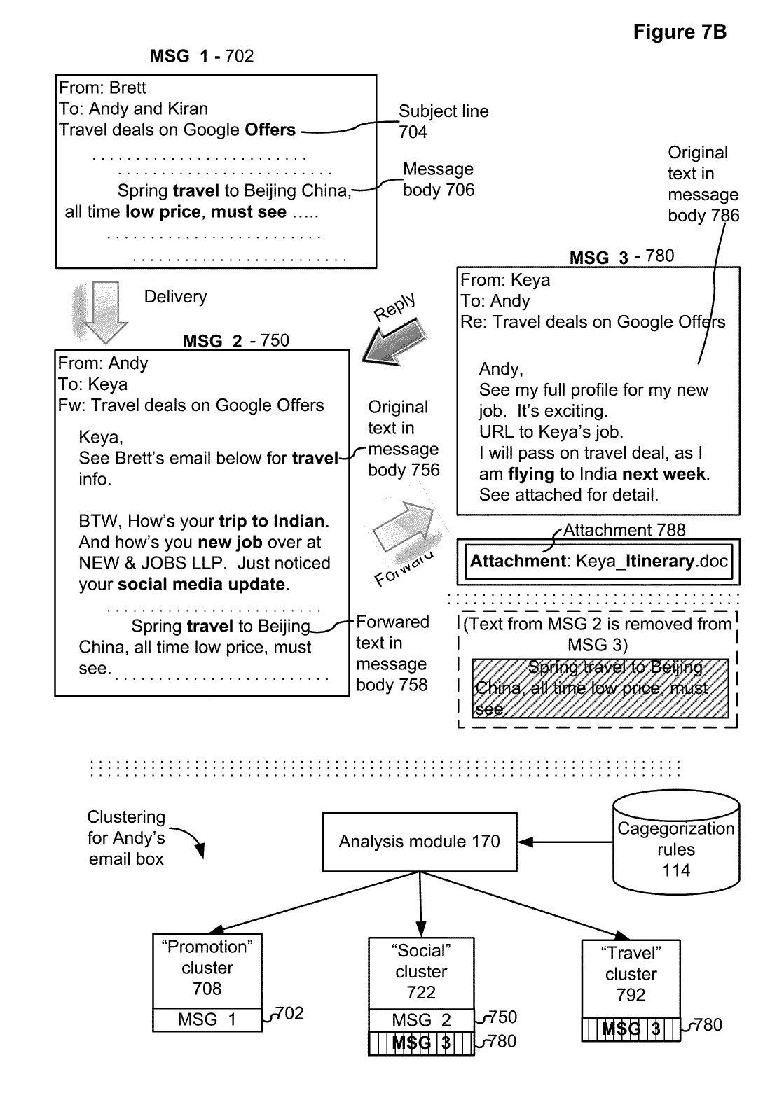

The method comprises detecting (502) occurrence of one or more categorization actions for a first object in a list of objects in a messaging application. In some embodiments, the categorization action detected is the receipt of a star on an object (504), detecting drag & drop action of an object from one cluster to another (506), detecting a filtering action on an object (508), or the detecting the addition of a label for an object (510). In some embodiments, the list of objects includes a plurality of objects, each object comprising one or more messages. Furthermore, at least one object in the list of objects includes at least two messages at are clustered without regard to content relatedness between the first message and the second message. Clustering of messages without regard to content relatedness (e.g. as distinct from clustering of messages based on conversation) is explained herein with respect to FIG. 4 and FIG. 7.

In some embodiments, the list of objects includes at least the first object and a second object, with second object comprising a first message and a second message that are clustered into the second object without regard to content relatedness between the first message and the second message. In some implementations, the first electronic message is contact information, an email message, an indication of a document, a calendar entry, an email label, a social network notification, a recent search query, a suggested search query, or a web search result.

The method further includes updating (512) a set of properties for the first object in accordance with the one or more categorization actions. For example, updating a set of properties for a respective object includes updating the object to include one or more a categorization rules for the categorization action. In some embodiments, updating the set of properties for the respective object also includes removing or overriding a system rule with one or more user rule for the categorization action.

In some embodiments, one or more rules are associated with a particular categorization action and updating the set of properties for the first object includes associating the object with the appropriate categorization rule(s) depending on system and user defined preferences. For instance, in some embodiments, one categorization rule associated with starring an object is to display the starred object at the top of a message display (e.g., at the top of a user's inbox). In some embodiments, another categorization rule associated with starring an object is to display the starred object in a priority cluster. In some embodiments, yet another categorization rule associated with a starred object is that the starred object continues to be displayed in its original cluster. In some embodiments, another categorization rule associated with starting an object is to display a star indicator with the object (e.g., starred objects are included in their original cluster with star indicators displayed). Alternatively, in some embodiments another categorization rule associated with a starred object is that the starred object is no longer displayed in its original cluster but is only displayed in a priority cluster.

In some embodiments, at least a subset of the one or more categorization rules is user-generated (e.g., starring an object) while other categorization rules are system-generated. In some embodiments, one categorization rules is a default rule for objects in a first cluster type. For example, for all messages in a first cluster which were sent to the user in reply to a previous user created message are automatically starred.

In some embodiments, one categorization rule is a default rule for all message clusters displayed in the listing of objects. For example, in some embodiments all message clusters displayed in an email application inbox are subject to a default categorization rule of not receiving a star when they are new. In some embodiments, the default rules override all other categorization rules.

The method further includes comparing (514) the updated set of properties for the first object to one or more categorization rules. For instance, in some embodiments, the set of properties for the first objet includes a set of categorization rules specific to the object. Other categorization rules are more general and apply across numerous objects and clusters. In some embodiments, the comparison is performed to ensure that all types of categorization rules are applied. In some embodiments a comparison is performed to determine which rules to apply, and in the case of conflicting rules, which rules override others. In some embodiments, the updated set of properties for the first object is the controlling rules when a conflict arises.

The method further includes, preparing (516) information for displaying the first object in the list of objects in accordance with the one or more categorization rules. In embodiments where the method is performed at the device 102, the method also includes displaying (518) the first object in the list of objects in accordance with the one or more categorization rules.

In some embodiments, a first categorization rule of the one or more categorization rules is to designate a starred message with a priority cluster. The updated set of properties for the first (e.g., starred) object includes or is associated with the first (e.g. priority cluster) categorization rule. As such, comparing updated set of properties for the first object to one or more categorization rules involves including or associating the first object with a priority cluster.

In some embodiments, the first object is associated with a first cluster (e.g. promotions cluster) of messages other than primary cluster and a second categorization rule of the one or more categorization rules is that the starred message continues to belong to the first cluster of messages.

In some embodiments, the first object is a single message, or a group of messages and prior to receiving the first categorization action, the first object is designated with a first cluster. A first categorization action of the one or more categorization actions is a user dragging the first object from the first cluster and dropping the first object into a second cluster. Furthermore, a first categorization rule of the one or more categorization rules is to designate the first object with the second cluster. In some embodiments, other subsequent messages from the originator of the first object are also designated with the second cluster. For instance, the user dragging the first object from the first cluster and dropping the first object into the second cluster also changes a first categorization rule for other messages from the originator of the first object. In other embodiments, other subsequent messages from the originator of the first object are not designated with the second cluster. For instance, dragging the first object from a first cluster and dropping the first object into a second cluster does not change a first categorization rule for other messages from the originator of the first object.

In some embodiments, a second categorization rule of the one or more categorization rules is to continue to designate the first object with the first cluster. In other embodiments, a second categorization rule of the one or more categorization rules is to no longer designate the first object with the first cluster.

In some embodiments, the first object is one or more electronic messages. Furthermore, a first categorization action of the one or more categorization actions is a user created label for the first object. For instance, the user creates a new cluster with a new name (e.g. “Work”). Then a first categorization rule of the one or more categorization rules is to designate the first object with a first cluster in accordance with the user created label (e.g., the first object should be identified with the new “Work” cluster.)

In some embodiments, prior to receiving the first categorization action, the first object is designated with a system created cluster; and a second categorization rule of the one or more categorization rules is to no longer designate the first object with the system created cluster (e.g., the first object is designated with the new “Work” cluster and not with the previous “Priority” cluster). In other embodiments, prior to receiving the first categorization action, the first object is designated with a system created cluster; and a second categorization rule of the one or more categorization rules is to continue to designate the first object with the system created cluster as well as the user created first cluster (e.g., the first object is designated with the new “Work” cluster and also continues to be designated with the “Priority” cluster as well.)

In some embodiments, the first object is one or more electronic messages. A first categorization action of the one or more categorization actions is a user created filter for the first object. The filter allows for a new designation for an object in an already existing cluster. For instance, the user created filter designates that the first object, which was previously designated with a “Promotions” cluster should now be designated with a “Travel” cluster (e.g., the “Travel” cluster previously existed but the first object was not previously not designated to the “Travel” cluster). Then a first categorization rule of the one or more categorization rules is to designate the first object with a first cluster in accordance with the user created filter (e.g., the first object is now designated with the “Travel” cluster).

In some embodiments, the first cluster is a system created cluster distinct from the first system related cluster. In other embodiments, the first cluster is a previously user created cluster (a.k.a., label) distinct from any system created clusters.

In some embodiments, prior to receiving the first categorization action, the first object is designated with a first system created cluster; and a second categorization rule of the one or more categorization rules is to no longer designate the first object with the first system created cluster (e.g., remove the first object from the “Promotions” cluster). In some embodiments, prior to receiving the first categorization action, the first object is designated with a first system created cluster; and a second categorization rule of the one or more categorization rules is to continue to designate the first object with the first system created cluster as well as with the first cluster (e.g., the first object is designated with the “Travel” cluster but also continues to be designated with the “Promotions” cluster as well.)

FIG. 6A illustrates a user interface 600 of an exemplary messaging application 150 for displaying clusters of objects in accordance with some implementations. The exemplary user interface 600 comprises an electronic message list 612. In some embodiments, the electronic message list 612 is displayed in an electronic message list panel (e.g., the portion of user interface 600 with a white background). The electronic message list 612 comprises a plurality of objects, such as object 602, object 604 and object 608. In some embodiments, a respective object in the plurality of objects is visually distinct in the electronic message list and represents one or more corresponding electronic messages in a plurality of electronic messages. For example, object 602 corresponds to a group or “cluster” of electronic messages (e.g., emails) having a collective association. In this case, the cluster of emails corresponding to object 602 comprises nine email messages relating to “Promotions,” such as retail sales, newsletters from stores or coupons from businesses. In another example, object 604 corresponds to a single email message from a user named Anna. In another example, object 608 corresponds to another form of a group of electronic messages having a collective association, an email conversation thread comprising at least two email messages having a collective association (e.g., based on subject of the email, recipients and senders or another an identification number).

FIG. 6A also illustrates detection of a user input categorization action 610-1 on an object in the electronic message list. More specifically, categorization action 610-1 is detected on object 604, corresponding to a user selection of a star for object 604.

FIG. 6B shows an exemplary response to detection of the categorization action 610-1. In response to detecting the occurrence of the categorization action 610-1 (starring of object 604), a set of properties for the object 604 is updated. The updated set of properties for the object 604 are compared to one or more categorization rules, and then information for displaying the object 604 in accordance the one or more categorization rules is prepared. FIG. 6B, illustrates that in this embodiment, object 604 is displayed in a priority cluster 618, in accordance with a categorization rule that the message is to be displayed in a priority cluster. In FIG. 6B, also illustrates that in this embodiment, object 604 is displayed with a displayed star 624 in the priority cluster, in accordance with a categorization rule that the message is to be displayed with a star.

It is noted that, in FIG. 6B, the user interface 600 includes one or more tabs, such as a first tab 618 for displaying a first cluster of electronic messages (e.g., electronic messages that are deemed to be priority electronic messages), a second tab 620 for displaying a second cluster of electronic messages (e.g., electronic messages that are deemed to be promotional messages), and a third tab 622 for displaying a third cluster of electronic messages (e.g., electronic messages that are deemed to be posts on social networks). The tab format is merely one exemplary mechanism for displaying various clusters. In FIG. 6B, the messages within the priority tab are displayed in the user interface 600, and the priority tab 618 is highlighted to indicate that its messages are in active display.

In some embodiments, an unselected tab is displayed with an indication of a number of unseen message in its cluster. For example, the second tab 620 in FIG. 6B is displayed with an indication of a number of electronic messages that have not been previously displayed (e.g., “9 Unseen”) in the group of electronic messages corresponding to the second tab 620 (e.g., promotional messages), and the third tab 622 is displayed with an indication of a number of electronic messages that have not been previously displayed (e.g., “2 Unseen”) in the group of electronic messages corresponding to the third tab 622 (e.g., social updates).

As such, FIGS. 6A and 6B collectively illustrate detecting user categorization action of a first object 604 of the plurality of objects in the electronic message list panel and, in response to detecting the categorization action of the first object, displaying of the first object in accordance with one or more categorization rules associated with the categorization action. Specifically, FIGS. 6A and 6B illustrate one embodiment of receiving a starring categorization action for a first object, and displaying the first objet in accordance with at least two categorization rules (e.g. the first rule being—displaying the message in the priority cluster and the second rule being—displaying the message with a star).

FIG. 6C illustrates detection of another user input categorization action 610-2 on an object the electronic message list. More specifically, categorization action 610-2 is drag and drop action on object 626. Object 626 was selected 628 by the user, dragged 630 and dropped 632 into the promotions tab 620 (for the promotions cluster). In response to detecting the occurrence of the categorization action 610-2 (drag and drop of object 626), a set of properties for the object 626 is updated. The updated set of properties for the object 626 are compared to one or more categorization rules, and then information for displaying the object 626 in accordance the one or more categorization rules is prepared.

FIG. 6C illustrates that in this embodiment, prior to receiving the categorization action 610-2, the object 626 was designated with a first cluster (the priority cluster 618). The categorization action was dragging 630 the object 626 from a first cluster (the priority cluster 618) and dropping 632 the object 626 into a second cluster (the promotions cluster 620).

FIG. 6D shows an exemplary response to detection of the drag and drop categorization action 610-2. In this example, the categorization rule is to designate the object 626 with the second cluster (the promotions cluster). As such, FIG. 6D illustrates that object 626 is now displayed in a promotions cluster 620.

In some embodiments, other subsequent messages from the originator of the first object are also designated with the second cluster. In other words, dragging the first object from the first cluster and dropping the first object into the second cluster, as illustrated in FIG. 6C also changes a first categorization rule for other messages from the originator of the first object. However, in other embodiments other subsequent messages from the originator of the first object are not designated with the second cluster. In other words, dragging the first object from a first cluster and dropping the first object into a second cluster does not change a first categorization rule for other messages from the originator of the first object.

FIG. 6E illustrates that in some embodiments, a second categorization rule of the one or more categorization rules is to continue to designate the first object with the first cluster, e.g. object 626 still appears in the priority cluster 618.

FIG. 6F illustrates that in some embodiments, a second categorization rule of the one or more categorization rules is to no longer designate the first object with the first cluster, e.g. object 626 no longer appears in the priority cluster 618.

FIG. 6G illustrates detection of another user input categorization action 610-3 on an object the electronic message list. More specifically, categorization action 610-3 is a labeling of object 640. The user selects object 640 and then selects “create new” 642 in order to create a new label for a new cluster. For instance, the user inputs a name, such as “Events” for object 640. In response to detecting the occurrence of the categorization action 610-3 (labeling of object 640), a set of properties for the object 640 is updated. The updated set of properties for the object 640 are compared to one or more categorization rules, and then information for displaying the object 640 in accordance the one or more categorization rules is prepared. In some embodiments, the first categorization action is a user created label for the object 640; and a first categorization rule is to designate the object 640 with the new cluster in accordance with the user created label as illustrated in FIG. 6H. It is noted that since this is a new label, the cluster will originally only contain the newly labeled object 640 (of one or more messages). However, subsequent messages which are related to with the labeled object will also be clustered in the new label. As illustrated in FIG. 6H, in some embodiments, the new user created label also is populated into a listing of both user created and system created clusters for the messaging system (e.g., “Events” 644.)

As illustrated in FIG. 6G, prior to receiving the first categorization action, the object 640 is designated with a system created cluster (the priority cluster 618). In some embodiments, a second categorization rule of the one or more categorization rules is to no longer designate the first object (e.g., 640) with the system created cluster, as illustrated in FIG. 6I (the object 640 is no longer designated in the priority cluster 618). Although, as illustrated in FIG. 6I, in some embodiments, the new user created label “Events” 644 is populated into a listing of both user created and system created clusters for the messaging system. In other embodiments, a second categorization rule of the one or more categorization rules is to continue to designate the first object with the system created cluster, as illustrated in FIG. 6J (the object 640 continues to be displayed in the priority cluster 618). As illustrated 6J, in some embodiments, the object 640 will include an indication of its additional label (e.g. “Events” 642) when it continues to be associated with and displayed in its original cluster.

FIG. 6K illustrates detection of another user input categorization action 610-4 on an object the electronic message list. More specifically, categorization action 610-4 is a filter for object 646. In some embodiments, a filter is a new designation for an object into an existing cluster. For instance, as illustrated in FIG. 6K, the user selects object 646 and then selects an existing cluster (the “Travel” cluster 648) in order to designate the travel cluster 648 with the object 646. In response to detecting the occurrence of the categorization action 610-4 (filtering of object 646), a set of properties for the object 646 is updated. The updated set of properties for the object 646 are compared to one or more categorization rules, and then information for displaying the object 646 in accordance the one or more categorization rules is prepared. In some embodiments, the first categorization action is a user created filter for the object 646; and a first categorization rule is to designate the object 646 with the newly designated cluster (e.g. “Travel” 648) in accordance with the filter as illustrated in FIG. 6L.

As illustrated in FIG. 6M, prior to receiving the first categorization action, the object 646 is designated with a system created cluster (the priority cluster 618). In some embodiments, a second categorization rule of the one or more categorization rules is to no longer designate the first object (e.g., 646) with the system created cluster, as illustrated in FIG. 6M (the object 646 is no longer designated in the priority cluster 618). In other embodiments, a second categorization rule of the one or more categorization rules is to continue to designate the first object with the system created cluster, as illustrated in FIG. 6N (the object 646 continues to be displayed in the priority cluster 618). As illustrated 6N, in some embodiments, the object 646 will include an indication of its additional label (e.g. “Travel” 648) when it continues to be associated with and displayed in its original cluster (e.g. the priority cluster 618).

In some embodiments, as illustrated in FIG. 6K both the old and newly filtered clusters are system created clusters (default cluster categories). In other embodiments, user created labels (e.g., the “Events” cluster 644 of FIG. 6J) can also be selected for filtering.

FIG. 7A is an example diagram illustrating a method 700 for clustering electronic message, in accordance with some implementations.

As shown in FIG. 7A, MSG 1 (702), which concerns “Travel deals on Google Offers,” is sent from Brett to Andy and Kiran. The subject line 704 includes “Travel deals on Google Offers” the message body 706 includes “Spring travel to Beijing China, all time low price, must see.” When analyzing MSG 1, based on categorization rules 114, the analysis module 170 determines that the subject line 704 includes a keyword (“deals”) and that the message body includes a key phrase (“low price”), and based on these determinations, concludes that MSG 1 is a “Promotion” message and places MSG 1 in the “Promotion” cluster 708.

As also shown in FIG. 7A, MSG 2 (710), a reply to MSG 1 (702), is sent by Andy to Brett and Kiran. The subject line 714 includes “Re: Travel deals on Google Offers”; the message body includes both original text 716 and quoted text (carried-over text) 718. The original text 716 includes:
“Brett,
Never mind the travel deal. Check out my new Google Hangout profile.”

The quoted text 718 includes:
“Spring travel to Beijing China, all time low price, must see.”

In this example, the analysis module 170 analyzes content of MSG 2 independently, e.g., without regard to MSG 1, despite the fact that MSG 2 is a reply to MSG 2. For example, based on the categorization rules 114, the analysis module 170 determines that quoted text 718 includes the phrase “Google Hangout profile” and that therefore MSG 2 is a “Social” email. Consequently, MSG 2 is placed in the “Social” cluster 722, rather than in the “Promotion” cluster 708. Note that in this example, original text 716 is preferred to the quote text 718 (e.g., accorded more weight), when MSG 2 is analyzed and clustered. In other implementations, original text 716 is less preferred to or treated equally as the quote text 718 (e.g., accorded less or same weight, respectively), because in some cases quoted text reflects more accurately the original/initial intent of email thread/conversation.

FIG. 7B is an example diagram illustrating a method for clustering electronic message, in accordance with some implementations.

As shown in FIG. 7B, MSG 1 (702), which concerns “Travel deals on Google Offers,” is sent from Brett to Andy and Kiran. The subject line 704 includes “Travel deals on Google Offers” the message body 706 includes “Spring travel to Beijing China, all time low price, must see.” When analyzing MSG 1, based on categorization rules 114, the analysis module 170 determines that the subject line 704 includes a keyword (“deals”) and that the message body includes a key phrase (“low price”), and based on these determinations, concludes that MSG 1 is a “Promotion” message and places MSG 1 in the “Promotion” cluster 708.

As also shown in FIG. 7B, Andy sends MSG 2 (750) (by forwarding MSG 1 with additional content) to Keya; MSG 2 includes original text in message body 756 (e.g., content by Andy to Keya that is not within MSG 1) and forwarded text in message body 758 (e.g., a portion of MSG 1).

Concerning MSG 2, the analysis module 170 determines that the original text in message body 756 includes the phrase “trip to Indian” (a typo, but still indicative of a “Travel” email), and the phrases “new job” and “social media update” (both of which are indicative of a “Social” email). In this example, the analysis module 170 disregards (e.g., without regard to) the fact that MSG 1 relates to MSG 2 (e.g., MSG 2 includes a forward of a portion in MSG 1), but identifies MSG 2 as a “Social” email—based on the fact that the original text in message body 756 includes more social related content (“new job” and “social media update”) than travel relate content (“trip to Indian”) and places MSG 2 in the “Social” cluster 722.

As further shown in FIG. 7B, Keya replies to Andy (by replying MSG 2 with MSG 3); MSG 3 (780) includes original text in message body 786 (e.g., content by Keya to Andy that is not within MSG 1 or MSG 2), but excludes text from MSG 2 (e.g., the original text in message body 756 and the forwarded text in message body 758). In addition, MSG 3 also includes an attachment 788 that is independent of the original text in message body 786.

Concerning MSG 3, the analysis module 170 determines that the original text in message body 786 includes a URL to a particular website known for having social and professional updates, which is highly indicative of a “Social” email.

The analysis module 170 further analyzes the attachment 788 and determines that name of the attachment 788 includes the words “Keya” and “Itinerary” (the combination of which suggests a personal travel itinerary, and thus a “Travel” email).

In this example, the analysis module 170 additionally takes into consideration (e.g., with regard to) the relationships among MSG 1, MSG 2, and MSG 2: (i) MSG 3 is a directly reply to MSG 2 (a “Travel email”), which weighs in favor of classifying MSG 3 as a “Travel” email; (ii) MSG 3 indirectly relates to MSG 1 (a “Travel” email), which also weighs in favor of classifying MSG 3 as a “Travel” email; and (iii) MSG 3 does not includes text found in both MSG 1 and MSG 2 (e.g., the message body 706 or the forward text in message body 758), which weighs against or in disfavor of classifying MSG 3 as “Travel” email.

Based on these determinations, in this example, the analysis module 180, using content-based clustering rules 114, classifies MSG 3 as both a “Social” email and a “Travel” email, and accordingly places MSG 3 in both the “Social” cluster 722 and the “Travel” cluster 792.”

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail. The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method comprising:
at a computer system having one or more processors, and memory storing one or more programs for execution by the one or more processors:
detecting occurrence of one or more categorization actions for a first object in a list of objects in a messaging application, wherein the list of objects includes at least the first object and a second object, and wherein the second object comprises a first message and a second message that are clustered into the second object without regard to content relatedness between the first message and the second message;
updating a set of properties for the first object in accordance with the one or more categorization actions;
comparing the updated set of properties for the first object to one or more categorization rules; and
preparing information for displaying the first object in the list of objects in accordance with the one or more categorization rules.

2. The method of claim 1, wherein:
the first object is a single message;
a first categorization action of the one or more categorization actions is starring the first object; and
a first categorization rule of the one or more categorization rules is to designate a starred message with a priority cluster.

3. The method of claim 2, wherein:
the first object is associated with a first cluster of messages; and
a second categorization rule of the one or more categorization rules is that the starred message continues to be associated with the first cluster of messages.

4. The method of claim 1, wherein:
the first object is a single message, and prior to detecting the one or more categorization actions, the first object is designated with a first cluster;
a first categorization action of the one or more categorization actions is dragging the first object from the first cluster and dropping the first object into a second cluster; and
a first categorization rule of the one or more categorization rules is to designate the first object with the second cluster.

5. The method of claim 4, wherein, responsive to the first categorization action, other subsequent messages from the originator of the first object are also designated with the second cluster.

6. The method of claim 4, wherein, responsive to the first categorization action, other subsequent messages from the originator of the first object are not designated with the second cluster.

7. The method of claim 4, wherein a second categorization rule of the one or more categorization rules is to continue, responsive to the first categorization action, to designate the first object with the first cluster.

8. The method of claim 4, wherein a second categorization rule of the one or more categorization rules is to, responsive to the first categorization action, no longer designate the first object with the first cluster.

9. The method of claim 1, wherein:
the first object is one or more electronic messages;
a first categorization action of the one or more categorization actions is creation of a label for the first object by a user; and
a first categorization rule of the one or more categorization rules is to designate the first object with a first cluster associated with the label.

10. The method of claim 9 wherein:
prior to detecting an occurrence of the first categorization action, the first object is designated with a system created cluster; and
a second categorization rule of the one or more categorization rules is, responsive to detection of the first categorization action, to no longer designate the first object with the system created cluster.

11. The method of claim 9 wherein:
prior to detecting an occurrence of the first categorization action, the first object is designated with a system created cluster; and
a second categorization rule of the one or more categorization rules is, responsive to detection of the first categorization action, to continue to designate the first object with the system created cluster.

12. The method of claim 1, wherein:
the first object is one or more electronic messages;
a first categorization action of the one or more categorization actions is a creation of a filter for the first object by a user; and
a first categorization rule of the one or more categorization rules is to designate the first object with a first cluster in accordance with the filter.

13. The method of claim 12, wherein:
prior to detecting an occurrence of the first categorization action, the first object is designated with a first system created cluster; and
a second categorization rule of the one or more categorization rules is, responsive to detection of the first categorization action, to no longer designate the first object with the first system created cluster.

14. The method of claim 12, wherein:
prior to detecting an occurrence of the first categorization action, the first object is designated with a first system created cluster; and
a second categorization rule of the one or more categorization rules is, responsive to detection of the first categorization action, to continue to designate the first object with the first system created cluster.

15. The method of claim 12, wherein:
prior to detecting an occurrence of the first categorization action, the first object is designated with a first system related cluster; and
the first cluster is a second system related cluster distinct from the first system related cluster.

16. The method of claim 12, wherein:
prior to detecting an occurrence of the first categorization action, the first object is designated with a first system related cluster; and
the first cluster is a user created cluster distinct from the first system related cluster.

17. The method of claim 1, further comprising:
displaying the first object in the list of objects in accordance with the one or more categorization rules.

18. The method of claim 1, wherein the first message is: contact information, an email message, an indication of a document, a calendar entry, an email label, a social network notification, a recent search query, a suggested search query, or a web search result.

19. A computing system, comprising:
one or more processors;
memory storing one or more programs to be executed by the one or more processors;
the one or more programs comprising instructions for:
detecting occurrence of one or more categorization actions for a first object in a list of objects in a messaging application, wherein the list of objects includes at least the first object and a second object, and wherein the second object comprises a first message and a second message that are clustered into the second object without regard to content relatedness between the first message and the second message;
updating a set of properties for the first object in accordance with the one or more categorization actions;
comparing the updated set of properties for the first object to one or more categorization rules; and
preparing information for displaying the first object in the list of objects in accordance with the one or more categorization rules.

20. A non-transitory computer readable storage medium storing one or more programs configured for execution by a computer, the one or more programs comprising instructions for:
detecting occurrence of one or more categorization actions for a first object in a list of objects in a messaging application, wherein the list of objects includes at least the first object and a second object, and wherein the second object comprises a first message and a second message that are clustered into the second object without regard to content relatedness between the first message and the second message;
updating a set of properties for the first object in accordance with the one or more categorization actions;
comparing the updated set of properties for the first object to one or more categorization rules; and
preparing information for displaying the first object in the list of objects in accordance with the one or more categorization rules.
